(19) United States
(12) Patent Application Publication
(10) Pub. No.: US 2026/0061417 A1
(43) Pub. Date: Mar. 5, 2026

(54) FLUID SAMPLING SYSTEM AND METHOD OF USING THE SAME

(71) Applicant: HONEYWELL INTERNATIONAL INC., Charlotte, NC (US)

(72) Inventors: Debendra UTKARSH, Charlotte, NC (US); Santosh Nagapati HEGDE, Charlotte, NC (US); Daniel YEE, Charlotte, NC (US); Seong Eyl LEE, Charlotte, NC (US)

(21) Appl. No.: 19/253,105

(22) Filed: Jun. 27, 2025

(30) Foreign Application Priority Data
Jul. 3, 2024 (IN) 202411050990

(51) Int. Cl. B01L 3/00

(52) U.S. Cl. CPC B01L 3/502; B01L 2200/025; B01L 2200/026; B01L 2300/12; B01L 2300/123

(57) ABSTRACT

Various embodiments described herein relate to methods, apparatuses, and systems for sampling fluid and analyzing fluid samples. In various embodiments, a fluid sampling cartridge for capturing a fluid sample comprises a slide body configured for receiving a fluid sample within a fluid channel; a cartridge locator configured for physical engagement with a housing defined by a fluid sampling system to align the fluid sampling cartridge in an installed position within the housing; a body holder secured relative to the slide body and configured to be dynamically engaged with the cartridge locator, wherein the cartridge locator is configured to rotate about a central axis thereof relative to the body holder; wherein the fluid sampling cartridge is configured for arrangement within the housing in the installed position to facilitate execution of an imaging operation by the fluid sampling system with respect to the fluid sample captured in the fluid channel.

### CROSS-REFERENCE TO RELATED APPLICATION

This application claims priority pursuant to 35 U.S.C. 119(a) to Indian Patent Application number 202411050990, filed Jul. 3, 2024, which application is incorporated herein by reference in its entirety.

### FIELD OF THE INVENTION

Example embodiments of the present disclosure relate generally to analytics of fluid samples and, more particularly, to systems, apparatuses, and methods for sampling fluid and analyzing fluid samples.

### BACKGROUND

Applicant has identified many technical challenges and difficulties associated with sampling fluids and analyzing fluid samples. For example, many methods and systems fail to provide an effective mechanism that allows peritoneal dialysis (PD) effluent to be analyzed.

### BRIEF SUMMARY

Various embodiments described herein relate to methods, apparatuses, and systems for sampling fluid and analyzing fluid samples. In accordance with various embodiments of the present disclosure, a fluid sampling cartridge for capturing a fluid sample may comprise a slide body configured for receiving a fluid sample within a fluid channel defined within an interior of the slide body; a cartridge locator configured for physical engagement with at least a portion of a housing defined by a fluid sampling system to at least partially align the fluid sampling cartridge in an installed position within the housing of the fluid sampling system; a body holder secured relative to the slide body and configured to be dynamically engaged with the cartridge locator to at least partially secure the cartridge locator relative to the slide body in one or more direction, wherein dynamic engagement of the cartridge locator relative to the body holder is defined by the cartridge locator being configured to rotate in one or more directions about a central axis thereof relative to the body holder; wherein the fluid sampling cartridge is configured to facilitate selective arrangement of the fluid sampling cartridge between a locked configuration and an unlocked configuration within the housing of the fluid sampling system based at least in part on one or more relative movements of the cartridge locator with respect to the body holder dynamically engaged therewith; wherein the fluid sampling cartridge is configured for arrangement within the housing of the fluid sampling system in the installed position to facilitate execution of an imaging operation by the fluid sampling system with respect to the fluid sample captured in the fluid channel while the fluid sampling cartridge remains in the installed position within the housing.

In various embodiments, the fluid sampling cartridge may be configured for arrangement within a housing of a fluid sampling system such that the fluid sample captured within the fluid channel is disposed within a field of view of an imaging device disposed within the housing of the fluid sampling system. In certain embodiments, the fluid sampling cartridge may be configured to enable an imaging of the fluid sample captured within the fluid channel by the imaging device at an instance during operation of the fluid sampling system in which a volume of fluid is flowing through the fluid channel. In various embodiments, the fluid sampling cartridge may be configured to facilitate the imaging of the fluid sample defined by the imaging device executing a digital holography imaging technique. In various embodiments, the fluid sampling cartridge is configured such that upon being arranged in the installed position, the cartridge locator is configured to physically engage one or more biasing plungers at a bottom surface of the cartridge locator to facilitate a securing of the fluid sampling cartridge in the installed position based at least in part on one or more biasing forces being applied thereto.

In various embodiments, the body holder may be made of an at least partially flexible material. In various embodiments, the cartridge locator may be made of an at least substantially rigid material. In various embodiments, the slide body may comprise one or more alignment rails provided along at least a portion of an exterior side edge of the slide body, the one or more alignment rails being configured to fit within an alignment channel defined by a fluid sampling cartridge engagement dock of the housing of the fluid sampling system to restrict the movement of the fluid sampling cartridge relative to the housing in one or more of a linear direction and a rotational direction. In various embodiments, the fluid sampling cartridge may further comprise one or more haptic elements defined along an exterior surface of the cartridge locator configured to facilitate user interaction with the fluid sampling cartridge. In various embodiments, the fluid sampling cartridge may be configured to be received within the housing of the fluid sampling system such that, upon being arranged in the installed position, at least a portion of the cartridge locator is accessible via a top side of the housing for user engagement therewith.

In various embodiments, the selective adjustment of the fluid sampling cartridge between the locked configuration and the unlocked configuration may be defined by a dual-action, multi-directional adjustment of the cartridge locator relative to the body holder that causes the cartridge locator to be moved relative to a locking pin defined within a fluid sampling cartridge engagement dock defined by the housing of the fluid sampling system. In various embodiments, the cartridge locator may define a locking pin slot configured to receive the locking pin defined by the housing of the fluid sampling system such that, upon the fluid sampling cartridge being arranged in the installed position, the locking pin restricts the fluid sampling cartridge from moving in one or more directions relative to the housing of the fluid sampling system. In certain embodiments, the locking pin slot may have a multi-directional configuration defined by a first portion extending from a slot opening in a first direction and a second portion extending from the first direction in a second direction to a slot retention end, wherein the first direction and the second direction are at least substantially different from one another. Further, in certain embodiments, the first direction and the second direction may be at least substantially perpendicular to one another. In certain embodiments, the fluid sampling cartridge may be configured such that the locking pin defined by the fluid sampling system being moved from the slot opening to the pin retention end requires a linear movement of the cartridge locator relative to the body holder in a first linear direction and a rotational movement of the cartridge locator relative to the body holder in a first rotational direction. Further, in various embodiments, the fluid sampling cartridge may be configured such that the locking pin defined by the fluid sampling system being moved from the slot opening to the pin retention end further requires a second linear movement of the cartridge locator relative to the body holder in a second linear direction opposite the first linear direction.

In various embodiments, the slide body may be made of an at least substantially transparent material configured to facilitate a fluid imaging operation wherein the fluid sample captured within a fluid channel is imaged by an imaging device disposed within the housing of the fluid sampling system. In various embodiments, the fluid sampling cartridge may further comprise an inlet conduit through which the fluid channel receives the fluid sample and an outlet conduit through which at least a portion of the fluid sample is dispensed from the fluid channel. In various embodiments, the fluid sampling cartridge may further comprise an inlet tube defining a conduit configured to be connected to a peritoneal dialysis (PD) drain bag at a first tube end thereof and the slide body at an opposite second tube end thereof to establish a fluid connection between the PD drain bag and the slide body. In various embodiments, the fluid sampling cartridge may further comprise an outlet tube defining a conduit configured to be connected to a fluid sampling system outlet at a first tube end thereof and the slide body at an opposite second tube end thereof to establish a fluid connection between the slide body and the fluid sampling system outlet.

The foregoing illustrative summary, as well as other exemplary objectives and/or advantages of the disclosure, and the manner in which the same are accomplished, are further explained in the following detailed description and its accompanying drawings.

### BRIEF DESCRIPTION OF THE DRAWINGS

The description of the illustrative embodiments may be read in conjunction with the accompanying figures. It will be appreciated that, for simplicity and clarity of illustration, elements illustrated in the figures have not necessarily been drawn to scale, unless described otherwise. For example, the dimensions of some of the elements may be exaggerated relative to other elements, unless described otherwise. Embodiments incorporating teachings of the present disclosure are shown and described with respect to the figures presented herein, in which:

FIG. 1 illustrates a perspective view of an example fluid sampling system in accordance with some example embodiments described herein;

FIGS. 2A-2C illustrate various perspective views of an example fluid sampling system in accordance with some example embodiments described herein;

FIG. 3 illustrates a cross-sectional view of an exemplary fluid sampling system in accordance with various embodiments described herein;

FIGS. 4A-4B illustrate various isolated views of an example fluid sampling cartridge engagement dock of a fluid sampling system in accordance with some example embodiments described herein;

FIG. 5 illustrates an exploded view of an example fluid sampling cartridge in accordance with some example embodiments described herein;

FIGS. 6A and 6B illustrate perspective views of a fluid sampling cartridge in accordance with various embodiments described herein;

FIGS. 7A and 7B illustrate perspective views of a fluid sampling cartridge in accordance with various embodiments described herein;

FIGS. 8A-8D illustrate various cross-sectional views of an exemplary fluid sampling system in accordance with various embodiments described herein; and,

FIGS. 9A and 9B illustrate cross-sectional views of an exemplary fluid sampling system in accordance with various embodiments described herein.

### DETAILED DESCRIPTION OF THE INVENTION

Some embodiments of the present disclosure will now be described more fully hereinafter with reference to the accompanying drawings, in which some, but not all embodiments of the disclosure are shown. Indeed, these disclosures may be embodied in many different forms and should not be construed as limited to the embodiments set forth herein; rather, these embodiments are provided so that this disclosure will satisfy applicable legal requirements. Like numbers refer to like elements throughout.

As used herein, terms such as “front,” “rear,” “top,” etc. are used for explanatory purposes in the examples provided below to describe the relative position of certain components or portions of components. Furthermore, as would be evident to one of ordinary skill in the art in light of the present disclosure, the terms “substantially” and “approximately” indicate that the referenced element or associated description is accurate to within applicable engineering tolerances.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

The term “electronically coupled,” “electronically coupling,” “electronically couple,” “in communication with,” “in electronic communication with,” or “connected” in the present disclosure refers to two or more elements or components being connected through wired means and/or wireless means, such that signals, electrical voltage/current, data and/or information may be transmitted to and/or received from these elements or components.

As described above, there are many technical challenges and difficulties associated with sampling fluids and analyzing fluid samples. For example, there are many technical challenges and difficulties related to medical analysis in renal care.

“Renal care” refers to medical care that provides diagnosis and treatment associated with the kidney (including but not limited to, chronic renal disease and/or acute renal disease). For example, when the patient's kidney stops working properly, renal care may include, but not limited to, performing dialysis procedures. The dialysis procedures are designed to remove waste products and excess fluids from the blood of the patient, and therefore improve the health of the patient.

Renal care is a huge federal expenditure, and medical care reimbursement guidelines are changing to shift more patients away from traditional hemodialysis (HD) to peritoneal dialysis (PD). In particular, PD provides a mechanism to remove waste products from a patient's blood when the patient's kidneys cannot adequately function, and PD is different from HD.

In particular, during an example PD procedure, a cleansing fluid (such as, but not limited to, a dialysis solution such as water with sugar and other additive) flows through a tube or a pipe (such as, but not limited to, a catheter) into the patient's body. More specifically, the cleansing fluid is injected into a part of a patient's abdomen. When the cleansing fluid is inside the patient's body, the cleansing fluid absorbs waste products from the patient's body. The lining of the abdomen (also known as peritoneum) can act as a filter and remove waste products from the patient's blood. After a set period of time, the fluid with the filtered waste products (referred herein as peritoneal dialysis (PD) effluent) flows out of the patient's abdomen and can be discarded.

In many instances, PD can be done by a patient at home. For example, a patient may use a PD machine to conduct PD procedure while the patient is sleeping. In contrast, HD must be performed in a health clinic by a trained healthcare professional. As such, PD can cost substantially less than HD, and can provide cost saving benefits.

However, PD procedures are faced with some drawbacks. One of the drawbacks is that patients who undergo PD may develop infections, which can force patients to switch back to HD. As such, early detection of infections after a patient undergoes PD can be beneficial for alerting patients, as well as care providers, so that early action can be taken to limit the severity and frequency of infections.

Various embodiments of the present disclosures overcome technical challenges and difficulties associated with sampling fluids and analyzing fluid samples, and address drawbacks faced by PD procedures. For example, various embodiments of the present disclosures include a fluid sampling and analyzing system in the field of peritoneal dialysis that provides an effective mechanism to sample and analyze PD effluent. For example, various embodiments of the present disclosure provide a fluid sampling system that can take sampling images of the PD effluent. The sampling images of the PD effluent are visually assessed to determine cell counts (such as, but not limited to, white blood cell count) of the fluid. For example, the more white blood cells that there are in the PD effluent, the more likely that the patient is having an infection as the white blood cells make the PD effluent cloudy. As such, various embodiments of the present disclosure can detect indicators of infections based on the PD effluent, and can have the potential to detect infections earlier (which can lead to better patient outcomes) and provide better specificity in the detection results (for example, based on the concentrations of white blood cells and/or types of white blood cells).

In some embodiments, the fluid sampling system works in tandem with a PD machine (also referred to as a “cycler”). For example, the fluid sampling system may be integrated into the PD machine. Additionally, or alternatively, the fluid sampling system may operate as a stand-alone device that is connected to the fluid conduit from the PD machine to receive the PD effluent. In particular, the fluid sampling system comprises a fluid imaging chamber that is disposable and/or removable from the fluid sampling system. As the PD effluent is pumped out of the patient's body, some of the fluid passes through the fluid imaging chamber. The fluid sampling system may also include an image sensor component that can generate digital holography image data of the PD effluent.

Various embodiments of the present disclosure relate to fluid sampling cartridges that may be configured for use in a fluid sampling system (e.g., a “PD machine”) to capture a fluid sample from a volume of fluid as it flows through the fluid sampling system. The fluid sampling cartridge may be configured to receive the volume of fluid and capture the fluid sample therefrom as the volume of fluid is flowing through the cartridge, such that the collection of the fluid sample does not interrupt the operation of the fluid sampling system. As described herein, such a configuration allows an imaging device of the fluid sampling system to capture images of the captured fluid sample without requiring the fluid sampling cartridge to be disassembled and/or removed from the fluid sampling system during operation.

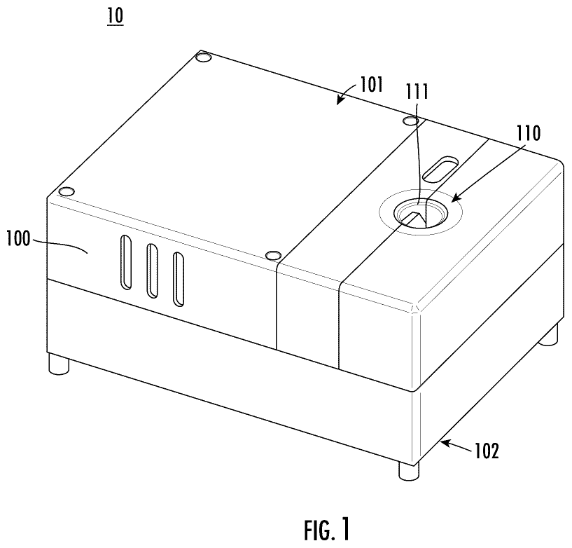

FIG. 1 illustrates a perspective view of an example fluid sampling system in accordance with some example embodiments described herein.

In various embodiments, an exemplary fluid sampling system 10 of an exemplary fluid sampling and analyzing system may be configured to execute a fluid sample collection operation and execute and/or facilitate a fluid sample analysis operation to determine one or more fluid characteristics associated with a volume of fluid. In various embodiments, an example fluid sampling system 10 may embody a machine configured to execute a fluid sample collection operation and, further, execute and/or facilitate a fluid sample analysis operation in order to determine one or more fluid characteristics associated with volume of fluid (e.g., via a fluid sample collected from the volume of fluid). For example, a fluid sample may be captured from the volume of fluid as part of the fluid sample collection operation, and the fluid sampling system 10 may further visually analyze the fluid sample using imaging data associated with the fluid sample (e.g., an image of the fluid sample), as described herein. In various embodiments, an exemplary fluid sampling cartridge may be utilized during operation of the fluid sampling system 10 to capture the fluid sample from a volume of fluid and facilitate the imaging of the fluid sample by an imaging device of the fluid sampling system 10.

While the description above provides an example fluid sampling system 10, it is noted that the scope of the present disclosure is not limited to the description above. In some examples, an example fluid sampling system 10 may define at least a portion of a fluid sampling and analyzing system and may comprise one or more additional and/or alternative elements. For example, an example fluid sampling and analyzing system comprising the example fluid sampling system 10, in accordance with embodiments of the present disclosure, may further comprise more than one remote computing server and/or more than one remote computing platform. Additionally, or alternatively, such an example fluid sampling and analyzing system comprising the fluid sampling system 10 in accordance with embodiments of the present disclosure may comprise a fluid sampling cartridge, as described herein, configured to be received within the fluid sampling system (e.g., in an installed position) to facilitate at least a portion of a fluid sample collection operation and/or a fluid sample analysis operation.

In various embodiments, an exemplary fluid sampling system 10 may comprise a housing 100 defining an interior housing portion in which one or more components of an exemplary fluid sampling system 10 described herein may be at least partially disposed and/or inserted. In various embodiments, the housing 100 may be made of at least substantially rigid materials (e.g., rigid plastic materials) and/or resilient materials (e.g., resilient polymeric materials). In various embodiments, the housing 100 may comprise a bottom surface 102 oriented to face a ground surface upon the housing 100 of the fluid sampling system 10 being disposed on the ground surface, and an opposing top surface 101 oriented to face away from the ground surface in at least substantially the opposite direction relative to the bottom surface 102.

In various embodiments, the housing 100 of the exemplary fluid sampling system 10 may comprise a fluid sampling cartridge engagement dock 110 configured to receive at least a portion of a fluid sampling cartridge therein to secure the fluid sampling cartridge relative to the housing 100. For example, the fluid sampling cartridge engagement dock 110 of the housing 100 may be defined by one or more surfaces and/or material recesses having a configuration corresponding to that of at least a portion of an exemplary fluid sampling cartridge such that upon being received within and/or engaged by the fluid sampling cartridge engagement dock 110, the fluid sampling cartridge is secured within an interior portion of the housing 100 in an installed position. In various embodiments, as illustrated, the fluid sampling cartridge engagement dock 110 may be defined at least in part by a receiving orifice 111 disposed along the top surface 101 of the housing 100, through which a fluid sampling cartridge may be inserted into the fluid sampling cartridge engagement dock 110 such that the housing 100 may secure the arrangement of the fluid sampling cartridge in the installed position, as described herein.

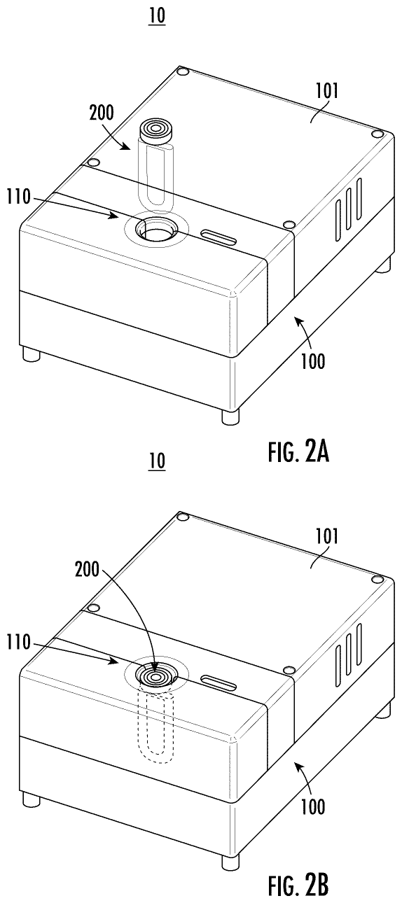

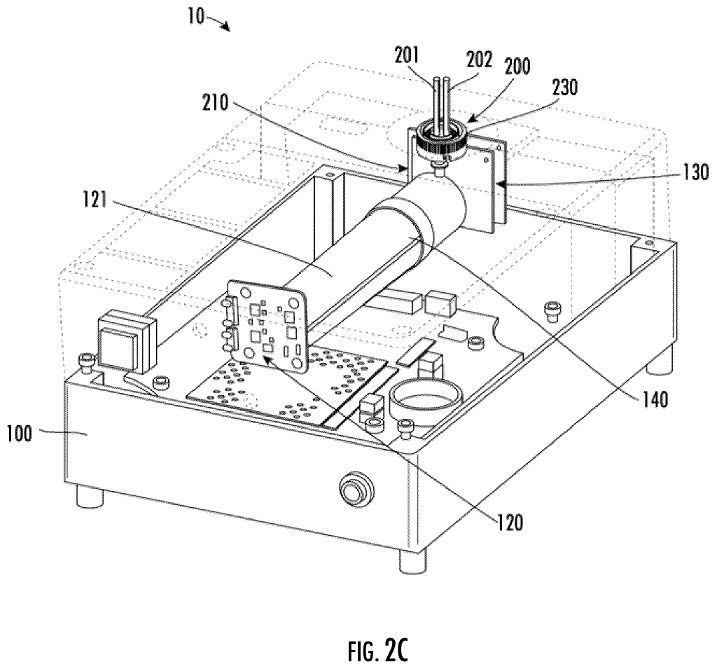

FIG. 2A illustrates an exploded view of an exemplary fluid sampling system and a fluid sampling cartridge configured for receiving a fluid sample from a volume of fluid within the fluid sampling system in accordance with various embodiments described herein. In particular, the example embodiment illustrated in FIG. 2A includes a fluid sampling system 10 and a fluid sampling cartridge 200 configured for use with the fluid sampling system 10 to execute a fluid sample capture operation and, further, a fluid sample analysis operation. The example fluid sampling system 10 may be configured to receive the fluid sampling cartridge 200 at a receiving orifice 111 disposed along the top surface 101 of the housing 100. For example, the receiving orifice 111 may be defined by an opening (e.g., defined by the fluid sampling cartridge engagement dock 110) in the top surface 101 of the housing 100 that fluidly connects the fluid sampling cartridge engagement dock 110 disposed within an interior housing portion of the housing 100 with the external environment in which the fluid sampling system 10 is located. In such an exemplary configuration, the fluid sampling system 10 may be configured such that a user may provide a fluid sampling cartridge 200 from an external environment through the receiving opening 111, and into a physical engagement with at least a portion of the fluid sampling cartridge engagement dock 110 disposed within the housing 100 such that the fluid sampling cartridge 200 may be secured relative to the fluid sampling cartridge engagement dock 110 in the installed position, as described herein.

For example, FIG. 2B illustrates a perspective view of an example fluid sampling system 10 with the fluid sampling cartridge 200 described above in reference to FIG. 2A disposed within the fluid sampling cartridge engagement dock 110 in an installed position in accordance with various embodiments described herein. In various embodiments, the fluid sampling system 10 may be configured such that the fluid sampling cartridge 20, upon being inserted into the fluid sampling cartridge engagement dock 110 (e.g., via the receiving opening 111) physically engages at least a portion of the fluid sampling cartridge engagement dock 110 provided within the interior housing portion of the housing 100. As described in further detail herein, the fluid sampling cartridge engagement dock 110 of the fluid sampling system 10 may be configured to at least temporarily secure the fluid sampling cartridge 200 in an installed position defined by at least a portion of the fluid sampling cartridge 200 (e.g., at least a portion of a sampling slide thereof) being arranged within the interior housing portion of the housing 100 along a line of sight of an imaging device of the fluid sampling system 10.

In various embodiments, as illustrated in FIG. 2B, the fluid sampling system 10 is configured such that an installed position of a fluid sampling cartridge 200 within the housing 100 is further defined by at least a top portion of the fluid sampling cartridge 200 (e.g., a portion of the cartridge locator, the holder element, and/or a combination thereof) being disposed at least substantially proximate the receiving orifice 111. For example, in such an exemplary configuration, the at least a top portion of the fluid sampling cartridge 200 in the installed position may be accessible to a user for removal from within the housing 100 via the receiving orifice 111 in the top surface 101 of the housing 100, such as, for example, upon the fluid sampling cartridge having already been used for one or more fluid sample collection operations and/or fluid sample analysis operations. As described herein, the fluid sampling cartridge 200 may define a replaceable component configured for a single (e.g., one-time) use with the fluid sampling system 10 to execute a single fluid sample collection operation by capturing a fluid sample from a volume of fluid flowing through the fluid sampling system 10. For example, the example fluid sampling cartridge 200 may be configured such that, upon image data associated with the fluid sample captured therein being generated by the fluid sampling system 10, the fluid sampling cartridge 200 may be removed (e.g., by a user) from within the housing 100 of the fluid sampling system 10 by selectively disengaging the fluid sampling cartridge 200 from the fluid sampling cartridge engagement dock 110 and pulling the fluid sampling cartridge 200 out from the housing via the receiving orifice 111 defined on the top surface 101 of the housing 100.

FIG. 2C illustrates a perspective view of the example fluid sampling system 10 and the fluid sampling cartridge 200 installed therein, as shown in FIG. 2B, with a top portion of the housing 100 being illustrated as at least partially transparent to illustrate at least a portion of the components disposed within the interior housing portion of the fluid sampling system 10. As illustrated, in particular, FIG. 2C illustrates an exemplary replaceable fluid sampling cartridge 200 positioned in an installed position relative to an imaging device and an illumination device of an exemplary fluid sampling system. For example, as illustrated in FIG. 2C, a fluid sampling system 10 configured for utilizing an exemplary replaceable fluid sampling cartridge 200 to capture a fluid sample from a volume of fluid may comprise an illumination device 120 and an imaging device 130. For example, the exemplary replaceable fluid sampling cartridge 200 may be provided in an installed position within the housing 100 of the fluid sampling system 10 (e.g., relative to the illumination device 120 and/or the imagining device 130) to facilitate execution of a fluid sample collection operation, wherein a fluid sample is captured within a slide body of the replaceable fluid sampling cartridge 200. Further, the fluid sampling system 10 may be configured to utilize the illumination device 120 and the imaging device 130 to facilitate execution of a fluid sample analysis operation, wherein an image of at least a portion of the fluid sample captured within the slide body of the replaceable fluid sampling cartridge 200 is captured by the imaging device 130 and further analyzed by the fluid sampling system 10 (e.g., a controller) to determine at least one fluid characteristic of the fluid sample, such as, for example, white blood cell type, white blood cell concentration, and/or the like.

In various embodiments, an exemplary fluid sampling system 10 may comprise at least one illumination device. In the exemplary embodiment shown in FIG. 2C, an exemplary illumination device 120 is illustrated. For example, the illumination device 120 may be configured to produce, generate, emit, and/or trigger the production, generation, and/or emission of light. The example illumination device 120 may include, but is not limited to, laser diodes (for example, UV, visible, or IR laser diodes, edge-emitting laser diodes, surface-emitting laser diodes, and/or the like). Additionally, or alternatively, the illumination device 120 may comprise one or more light-emitting diodes (LEDs). Additionally, or alternatively, the illumination device 120 may comprise one or more other forms of natural and/or artificial sources of light.

In some embodiments, at least one illumination device 120 is configured to emit at least one light beam. In some embodiments, the at least one light beam emitted by the at least one illumination device 120 may comprise coherent light. In the present disclosure, the term “coherent light” refers to a light beam where the wavefront has a synchronized phase. Examples of coherent light include, but are not limited to, laser light. For example, the light beam in laser light has the same frequency and phase. In some embodiments, to emit coherent light, the at least one illumination device includes, but is not limited to, laser diodes (for example, UV, visible, or IR laser diodes, edge-emitting laser diodes, surface-emitting laser diodes, and/or the like).

In some embodiments, the at least one light beam emitted by the at least one illumination device may comprise incoherent light or at least partially incoherent light. In the present disclosure, the term “incoherent light” (or “low coherence light” as used interchangeably herein) refers to a light beam where the wavefront does not have a synchronized phase. For example, incoherent light does not contain photons with the same frequency and does not have wavelengths that are in phase with one another. In some embodiments, to emit incoherent light, the at least one illumination device includes, but is not limited to, light-emitting diodes (LEDs).

In various embodiments, an exemplary fluid sampling system 10 may be configured such that at least one light beam emitted by the illumination device 120 is directed towards the slide body of a replaceable fluid sampling cartridge 200 disposed in an installed position within the housing 100 (e.g., within the fluid sampling cartridge engagement dock defined by the housing 100). As described herein, the slide body of the fluid sampling cartridge 200 may comprise a transparent material that enables the at least one light beam emitted from the illumination device 120 to pass therethrough. For example, the at least one light beam may further pass through the fluid sample captured within the fluid sampling cartridge 200 (e.g., a portion of the fluid sample disposed within the receiving area defined by the slide body of the fluid sampling cartridge 200).

In some embodiments, the imaging device 130 comprises an image sensor configured to capture at least one image of a fluid sample captured within the fluid sampling cartridge 200. For example, the imaging device 130 may generate digital holography image data associated with the fluid sample suspended within the receiving area of the fluid sampling cartridge 200.

In the present disclosure, the term “digital holography image data” refers to image data that is generated based on digital holography techniques, including, but not limited to, lensless holography techniques. For example, the digital holography image data may be generated by the image sensor without any imaging lenses and without any adjustments. In such an example, there are no imaging lenses between the fluid sampling cartridge 200 and the image sensor. The digital holography image data may comprise a digital holography image of the fluid sample (for example, a digital holography image of various particles, cells, etc. in the fluid sample). In some embodiments, the digital holography image is blurry and/or out of focus, and example embodiments of the present disclosure may generate focused images associated with the fluid sample based at least in part on the digital holography image, details of which are described herein.

In some examples, the image sensor may comprise one or more imagers and/or image sensors. Various examples of the image sensor may include, but are not limited to, a charge-coupled device (CCD), a complementary metal-oxide semiconductor (CMOS) sensor, and/or the like. As described above, in some embodiments, the image sensor does not comprise any lenses so as to generate digital holography image data based on lensless holography techniques.

While the description above provides an example of implementing digital holography techniques, it is noted that the scope of the present disclosure is not limited to the description above. In some examples, an example fluid sample imaging system may implement other imaging techniques. For example, example embodiments of the present disclosure may implement optical microscopy as the imaging technique. Additionally, or alternatively, example embodiments of the present disclosure may implement ultraviolet (UV) fluorescence as the imaging technique.

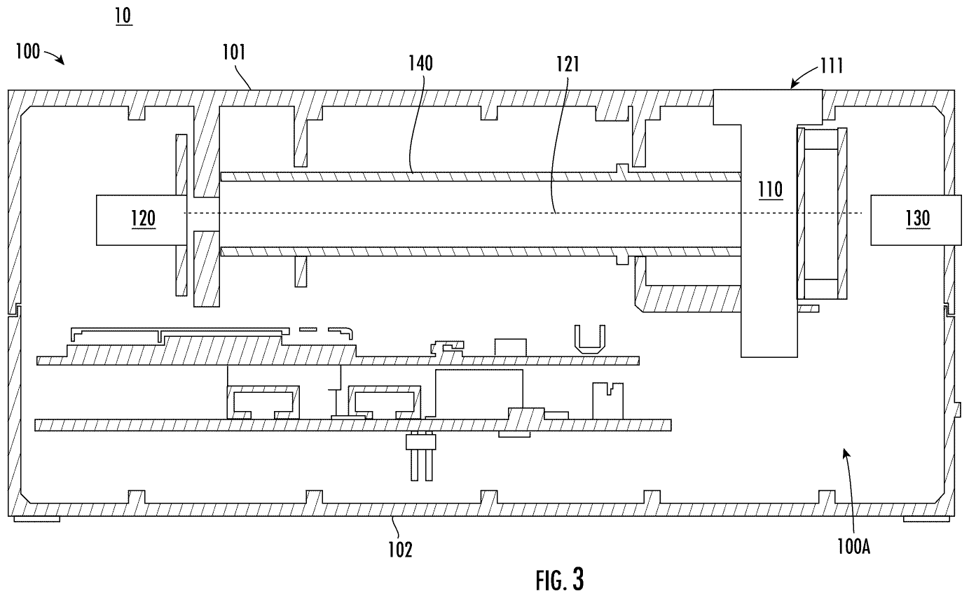

While the exemplary embodiment illustrated in FIG. 3C provides an example positional arrangement between the housing 100, illumination device 120, the imaging device 130, and an exemplary replaceable fluid sampling cartridge 200 in an installed position, it is noted that the scope of the present disclosure is not limited to the description above. In some examples, the housing 100, the illumination device 120, the imaging device 130, and/or the replaceable fluid sampling cartridge 200 may be positioned differently than those shown in FIG. 2C.

As described herein, the replaceable fluid sampling cartridge 200 may be positioned in an installed position wherein the fluid sampling cartridge 200 is at least substantially adjacent (e.g., in contact with or spaced a distance away from) the imaging device 130 of the fluid sampling system 10 such that the imaging device 130 may effectively capture one or more images of the fluid sample captured within the replaceable fluid sampling cartridge 200. As discussed herein, the fluid sampling cartridge 200 configured for use with the fluid sampling system 10 may be replaceable such that the fluid sampling cartridge 200 may be inserted into and/or removed from the installed position defined within the fluid sampling cartridge engagement dock of the housing 100 relative to the imaging device 130 and/or the illumination device 120 of the fluid sampling system 10. In various embodiments, a fluid sampling cartridge 200 may be configured to facilitate a removal thereof from the installed position within the fluid sampling cartridge engagement dock of the fluid sampling system 10 upon execution of the fluid sample analysis operation. For example, upon the replaceable fluid sampling cartridge 200 having captured a fluid sample within the slide body and one or more images of the fluid sample having been captured by the imaging device 130, the fluid sampling cartridge 200 may be removed from the installed position (e.g., removed from within the housing 100 defined by the fluid sampling system 10) and disposed or otherwise transported to a secondary location. For example, the removed fluid sampling cartridge 200 may be replaced with a different, unused fluid sampling cartridge 200, which may be utilized in executing a second (e.g., subsequent) fluid sample collection operation.

In various embodiments, an example fluid sampling system 10 may determine estimated sample characteristics data associated with the fluid sample based at least in part on the image data (e.g., the digital holography image data). As illustrated in FIGS. 2A and 2B, a removeable fluid sampling cartridge 200 may be received by the fluid sampling system 10 and secured in an installed position via an engagement with the fluid sampling cartridge engagement dock 110. As described herein, the fluid sampling cartridge 200 may be configured such that in the installed position, the fluid sampling cartridge 200 may be fluidly connected to a fluid inlet and fluid outlet of the fluid sampling system 10 such that a fluid sample (such as, but not limited to, peritoneal dialysis effluent, urine, oil, and/or the like) may be received by the fluid sampling cartridge 200 and the fluid sampling system 10 may generate image data (e.g., digital holography image data) associated with the fluid sample. For example, as described herein, the example fluid sampling system 10 may be configured to use an illumination device 120 and an imaging device 130 to generate image data and facilitate execution of a fluid sample collection operation and/or fluid sample analysis operation.

In various embodiments, the estimated sample characteristics data used to determine the one or more fluid characteristics of the collected fluid sample may be based at least in part on the image data generated by the fluid sampling system 10. In various embodiments, the estimated sample characteristics data may comprise an estimated concentration level of white blood cells within the fluid sample, estimated size values of particles within the fluid sample, and/or the like. Additionally, or alternatively, the fluid sampling system 10 may be in electronic communication with one or more mobile computing devices, a remote computing server, and/or another fluid sampling system to exchange data and information. In some embodiments, the fluid sampling system 10 may transmit the image data (e.g., digital holography image data) to the one or more mobile computing devices and/or the remote computing server defined by the exemplary fluid sampling and analyzing system defining the fluid sampling system 10 to facilitate a determination of one or more fluid characteristics of the collected fluid sample (e.g., estimated sample characteristics data associated with the fluid sample).

FIG. 3 illustrates a cross-sectional view of an exemplary fluid sampling system 10 in accordance with various example embodiments described herein. In particular, FIG. 3 illustrates a schematic representation of a cross-section of an example fluid sampling system 10 comprising a fluid sampling cartridge engagement dock 110 configured to receive and secure a replaceable fluid sampling cartridge in an installed position within the housing 100 to facilitate execution of a fluid sample capture operation using the fluid sampling cartridge. As illustrated, the fluid sampling system 10 may be configured to receive a fluid sampling cartridge within the fluid sampling cartridge engagement dock 110 and facilitate an interaction between the fluid sampling cartridge and a volume of fluid received by the fluid sampling system 10 that allows the fluid sampling cartridge to capture a fluid sample from a volume of fluid flowing through the fluid sampling system 10, as described herein. For example, the fluid sampling cartridge engagement dock 110 may be configured to engage a fluid sampling cartridge received within the housing 100 via the receiving orifice 111 and secure the fluid sampling cartridge in an installed position defined at least in part by an in-line fluid connection of the fluid sampling cartridge between a fluid inlet and a fluid outlet of the fluid sampling system 10.

In various embodiments, the fluid sampling cartridge engagement dock 110 may be defined at least in part by slot depth that extends from the receiving orifice 111 into the interior housing portion (e.g., towards the bottom surface 102) in a direction at least substantially perpendicular to the top surface 101. In various embodiments, the exemplary fluid sampling system 10 may be configured to facilitate operability with an exemplary fluid sampling cartridge having a removeable and/or replaceable configuration, wherein the fluid sampling cartridge is configured to be selectively inserted and/or removed from the fluid sampling cartridge engagement dock 110 of the housing 100 to enable execution of one or more fluid sample capture operations by the fluid sampling system 10.

Further, in various embodiments, the fluid sampling system 10 may be configured such that a fluid sampling cartridge secured in the installed position is arranged within the interior housing portion 100A of the housing 100 such that with at least a portion of the fluid sampling cartridge being disposed in between an illumination device 120 and an imaging device 130. The fluid sampling system 10 may be configured such that, upon a fluid sampling cartridge installed within the fluid sampling cartridge engagement dock having captured a fluid sample from the volume of fluid flowing through the fluid sampling system 10 (e.g., within a sampling slide thereof), a fluid sample analysis operation may be executed by the fluid sampling system 10, such as, for example, by using the illumination device 120 to illuminate at least a portion of the fluid sample within the fluid sampling cartridge and capturing an image of the illuminated fluid sample with the imaging device 130 while the fluid sampling cartridge is still disposed in the installed position in the fluid sampling system 10.

For example, in various embodiments, an example fluid sampling system 10 may be configured to receive different volumes of fluid from which one or more fluid sampling cartridges disposed within the fluid sampling cartridge engagement dock 110 defined by the housing 100 may capture a respective fluid sample. In some embodiments, the fluid sample is associated with PD effluent. For example, the fluid sample may comprise PD effluent. In the present disclosure, the term “PD effluent” refers to a liquid that is discharged from a PD procedure. For example, the PD effluent may be a liquid that is discharged from a patient's body as an end product from performing a PD procedure on the patient. As described above, a dialysis solution is injected into the patient's body when a PD procedure is performed on the patient. The dialysis solution dwells within the patient's body and eventually is discharged as a PD effluent. In some embodiments, the PD effluent may be received from a PD machine. For example, a discharging conduit of the PD machine that discharges fluids from the PD procedure can be connected to a fluidic inlet. In such an example, the fluid discharged from the PD machine is the PD effluent. As described above, the fluidic outlet may be connected to a fluid output conduit to discharge the PD effluent.

While the description above provides an example of a fluid sample, it is noted that the scope of the present disclosure is not limited to the description above. In some examples, an example fluid sample may comprise one or more additional and/or alternative fluids. For example, the fluid sample may comprise urine. Additionally, or alternatively, the fluid sample may comprise oil. Additionally, or alternatively, the fluid sample may comprise blood.

As described herein, in various embodiments, the fluid sampling system 10 may comprise an illumination device 120 configured to emit one or more light beams 121 in order to facilitate a more effective and/or efficient imaging of the fluid sample captured by the fluid sampling cartridge 10. For example, in various embodiments, the illumination device 120 may be a laser, lamp, light-emitting diode (LED), and/or the like, which may be collectively configured to generate a light beam 121 (e.g., ultraviolet, visible, infrared, white, a single visible color, or multiple color light) that may be emitted toward the fluid sampling cartridge, as described herein in further detail. An illumination device 120 of the fluid sampling system 10 may be configured to emit one or more light beams so as to engage the slide body defined by the fluid sampling cartridge and illuminate at least a portion of the fluid sample captured therein. In various embodiments, as illustrated in FIG. 3, the fluid sampling system 10 may be configured such that the illumination device 120 is at least substantially aligned with the imaging device 130. Further, for example, the illumination device 120 may be arranged such that the light beam 121 emitted therefrom extends through a receiving area defined by the slide body of a fluid sampling cartridge in the installed position within the fluid sampling cartridge engagement dock 110 in a direction that is at least substantially aligned with the fluid sampling cartridge, such that at least a portion of the one or more light beams 121 illuminates the fluid sample disposed within the slide body thereof. As described herein, an imaging device 130 defined within the housing 100 of the fluid sampling system 10 may be configured to utilize the light beam 121 emitted from the illumination device 120 in order to capture an image of the fluid sample received by and/or passing through the fluid sampling cartridge using one or more imaging techniques such as, for example holographic microscopy (e.g., lensless holography) and/or the like.

In some embodiments, the example fluid sampling system 10 may comprise an optical tube 140. In some embodiments, the optical tube 140 comprises materials that block light (such as, but not limited to, opaque materials). For example, the optical tube 140 may prevent stray light from interfering with the at least one light beam emitted by the illumination device 120.

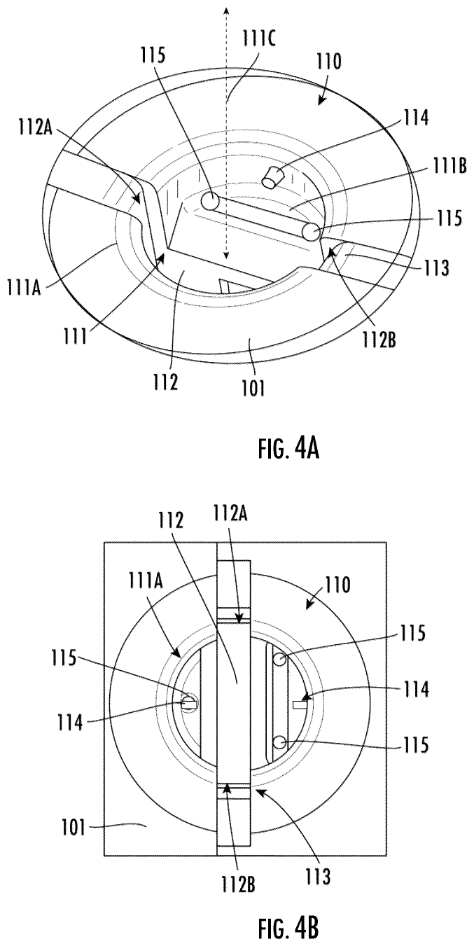

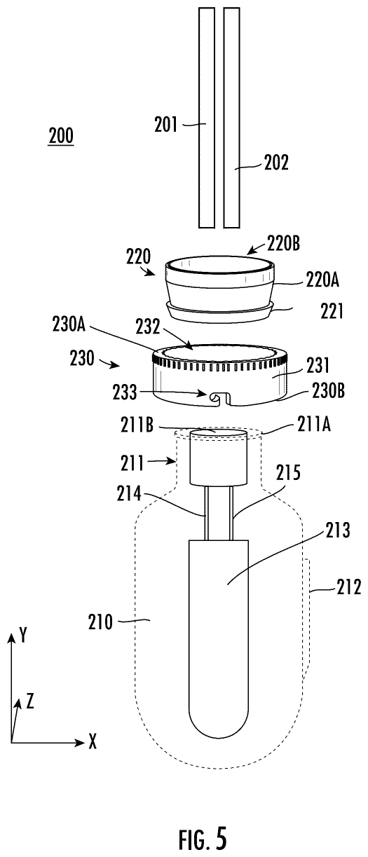

FIGS. 4A and 4B illustrate a perspective view and a top view, respectively, of an exemplary fluid sampling cartridge engagement dock defined by the housing of an exemplary fluid sampling system in accordance with various embodiments described herein. In particular, FIG. 4A illustrates a perspective view of an exemplary fluid sampling cartridge engagement dock 110 and FIG. 4B illustrates a top view of the exemplary fluid sampling cartridge engagement dock 110. In various embodiments, an exemplary fluid sampling cartridge engagement dock 110 may embody a receptacle configured to receive a fluid sampling cartridge therein and secure the fluid sampling cartridge in a preferred alignment within an interior housing portion of the housing a fluid sampling system. For example, in various embodiments, the fluid sampling cartridge engagement dock 110 may comprise one or more geometric features corresponding to the physical configuration of a replaceable fluid sampling cartridge such that the fluid sampling cartridge may be inserted therein and secured in a desired position, such as, for example, an installed position, relative to one or more other components within the interior housing portion of the housing of the fluid sampling system (e.g., an imaging device and/or an illumination device).

As illustrated in FIG. 4A, the fluid sampling cartridge engagement dock 110 may define a receiving orifice 111 defined at least in part by an opening along the top surface 101 of the housing. As illustrated, the receiving orifice 111 may embody a cavity defined by a sidewall 111A extending from the top surface 101 of the housing 100 into the interior housing portion of the housing to one or more recessed shelves 111B having a recessed configuration relative to the top surface 101 of the housing. In various embodiments, the sidewall 111A of the receiving orifice may be oriented in a direction at least substantially perpendicular to the top surface 101 of housing. Further, in various embodiments, the one or more recessed shelves 111B of the receiving orifice 111 may each be oriented to face in an upward direction at least substantially perpendicular to the sidewall 111A and at least substantially parallel to the top surface 101 of housing. In various embodiments, the receiving orifice 111 may be configured according to the configuration of an exemplary fluid sampling cartridge. For example, the length of the sidewall 111A and/or the perpendicular distance between the one or more recessed shelves 111B and the top surface 101 of the housing may be based at least in part on the cartridge locator length defined by the cartridge locator of the exemplary fluid sampling cartridge.

In various embodiments, an exemplary fluid sampling cartridge engagement dock 110 may comprise a slide body receptacle 112, one or more alignment channels 113, a locking pin 114, and one or more biasing plungers 115. As illustrated, in various embodiments, the fluid sampling cartridge engagement dock 110 may comprise a slide body receptacle 112 defined by a slot arranged along a central portion of the fluid sampling cartridge engagement dock 110. For example, the length and width of the slide body receptacle 112 may correspond to the slide body length and slide body width, respectively, defined by the slide body of an exemplary fluid sampling cartridge, such that the slide body may be received therein. In various embodiments, the slide body receptacle 112 may be defined at least in part by one or more grooves 112A, 112B distributed along the sidewall 111A of the receiving orifice 111 and configured to receive respective side edges of the slide body of the fluid sampling cartridge to facilitate proper angular orientation of the fluid sampling cartridge relative to the imaging device and/or the illumination device of the fluid sampling system upon the fluid sampling cartridge being received in the in the installed position in the fluid sampling cartridge engagement dock 110.

In various embodiments, the exemplary fluid sampling cartridge engagement dock 110 may further comprise one or more one or more alignment channels 113 provided along one or more of the grooves 112A, 112B defined by the slide body receptacle 112. The alignment channel 113 may be configured to receive the alignment rail defined by an exemplary fluid sampling cartridge as the fluid sampling cartridge is being inserted into the slide body receptacle 112. For example, the length and width of the alignment channel 113 may correspond to the length and width, respectively, defined by the alignment rail of the exemplary fluid sampling cartridge, such that the alignment rail may be received therein and further facilitate the restricted movement of a fluid sampling cartridge in an installed position relative to the fluid sampling cartridge engagement dock 110 in one or more linear and/or rotational directions. For example, the alignment channel 113 defined along one or more of the grooves 112A, 112B may allow for the vertical movement of the alignment rail 212 of the slide body 110 into and/or out of the slide body receptacle 112 in one or more vertical directions to ensure a proper alignment of the slide body within the fluid sampling cartridge engagement dock 110 as the fluid sampling cartridge is being lowered into the installed position.

In various embodiments, the exemplary fluid sampling cartridge engagement dock 110 may further comprise a locking pin 114 defined by an at least substantially rigid pin protruding in an inward radial direction from an interior sidewall 111A of the receiving orifice 111 of the fluid sampling cartridge engagement dock 110. In various embodiments, as described herein, the locking pin 114 may be configured such that, upon a fluid sampling cartridge being received within the fluid sampling cartridge engagement dock 110 in a proper angular orientation corresponding to that of an installed position, the locking pin 114 may be received inserted into the locking pin slot defined by a cartridge locator of the fluid sampling cartridge. The locking pin 114 may function to physically engage at least a portion of the cartridge locator of an exemplary fluid sampling cartridge to secure the fluid sampling cartridge in a locked configuration in the installed position. For example, in various embodiments, the fluid sampling cartridge engagement dock 110 be configured such that, upon being received within the locking pin slot of the cartridge locator, the locking pin 114 may function as a physical obstacle that physically abuts one or more surfaces of the cartridge locator (e.g., the locking pin slot) to at least partially restrict the cartridge locator from moving (e.g., linearly and/or rotationally) relative to the fluid sampling cartridge. In various embodiments, an exemplary fluid sampling cartridge engagement dock 110 may comprise a plurality of locking pins 114 distributed at a plurality of locations along the sidewall 111A of the receiving orifice 111 defined by the fluid sampling cartridge engagement dock 110. For example, as illustrated, the fluid sampling cartridge engagement dock 110 may comprise a plurality of locking pins 114 including a first locking pin and a second locking pin disposed on opposite sides of the receiving orifice 111 such that the one or more forces applied thereto, such as, for example, from a physical engagement with respective surfaces of the cartridge locator of a fluid sampling cartridge disposed within the fluid sampling cartridge engagement dock, may be at least substantially evenly distributed about the central axis 111C of the receiving orifice 111.

In various embodiments, the exemplary fluid sampling cartridge engagement dock 110 may further comprise one or more biasing plungers 115 disposed along the one or more recessed shelves 111B of the receiving orifice 111 of the fluid sampling cartridge engagement dock 110. As illustrated, the one or more biasing plungers 115 may be oriented to extend from a recessed shelf 111B in an upward direction to engage at least a portion of a fluid sampling cartridge disposed within the fluid sampling cartridge engagement dock 110 and apply a biasing force thereto. For example, based at least in part on one or more forces acting thereon, a biasing plunger 115 may be configured between an extended state and a compressed state by moving along a linear axis at least substantially parallel to a central axis 111C defined by the receiving orifice 111. For example, an exemplary fluid sampling cartridge engagement dock 110 may be configured such that upon a fluid sampling cartridge being disposed therein, each of the one or more plungers 115 may engage a respective location on a bottom surface of the cartridge locator of the fluid sampling cartridge. In such an exemplary configuration, each of the one or more plungers 115 may impart a respective biasing force 115 on the cartridge locator.

FIG. 5 illustrates an exploded view of an example fluid sampling cartridge in accordance with various example embodiments described herein. In particular, FIG. 5 illustrates an exploded view of an example fluid sampling cartridge 200 configured to be removably inserted into a housing of an exemplary fluid sampling system (e.g., a housing 100 of an exemplary fluid sampling system 10, as illustrated in FIG. 1) and facilitate execution of a fluid sample collection operation by receiving a fluid sample therein from a volume of fluid within a fluid sampling system. As illustrated in FIG. 5, an exemplary fluid sampling cartridge 200 may be embodied as, for example, a replaceable slide comprising an inlet tube 201, an outlet tube 202, a slide body 210, a body holder 220, and a cartridge locator 230.

In various embodiments, an example fluid sampling cartridge 200 may comprise an inlet tube 201 defining a conduit configured to be connected to a peritoneal dialysis (PD) drain bag at a first tube end thereof and the slide body 210 of the fluid sampling cartridge 200 at an opposite second tube end thereof to establish a fluid connection between the PD drain bag and the slide body 210. For example, the inlet tube 201 may extend between the PD bag and the slide body 210 to facilitate a flow of a fluid (e.g., effluent) from the PD bag into the sampling channel 213 the slide body 210 for sampling and/or imaging by the fluid sampling system, as described herein. Further, the example fluid sampling cartridge 200 may comprise an outlet tube 202 defining a conduit configured to be connected to a fluid sampling system outlet (e.g., a disposal basin and/or any other location configured to facilitate the dispense of fluid from within the fluid sampling system) at a first tube end thereof and the slide body 210 of the fluid sampling cartridge 200 at an opposite second tube end thereof to establish a fluid connection between the slide body 210 and the fluid sampling system outlet. For example, the outlet tube 202 may extend between the slide body 210 and the fluid sampling system outlet to enable a fluid (e.g., at least a portion of an effluent sample) to flow out from within the slide body 210 into the fluid sampling system outlet, such as, for example, a disposal basin, for removal of the fluid from within the slide body 210 and the fluid sampling system. As illustrated, an exemplary slide body 210 may be defined at least in part by a top portion 211 having an at least substantially tubular configuration defining a hollow channel 211B therethrough and an exterior surface defined between the slide body 210 and an upper edge 211A of the top portion 211. In various embodiments, the fluid sampling cartridge 200 may be configured such that in an assembled configuration, a body holder 220 of the fluid sampling cartridge 200 is configured for arrangement around a perimeter of the top portion 211 of the slide body 210 such that the body holder 220 (e.g., an interior surface thereof) is physically engaged with at least a portion of the exterior surface of the top portion 211.

In various embodiments, an example fluid sampling cartridge 200 may comprise a slide body 210 made of an at least substantially transparent material configured to facilitate imaging, by an imaging device of the fluid sampling system, of a fluid sample captured within a fluid channel 213 (e.g., a microchannel) defined within an interior of the slide body 210. In various embodiments, as non-limiting examples, the slide body 210 may be made of a material configured for high optical performance, such as for example, a borosilicate glass, PMMA, and/or the like, or any other at least substantially transparent material configured such that an imaging device of the fluid sampling system can operably capture an image of a fluid sample disposed within the fluid channel 213 that may be used to generate image data corresponding to the captured fluid sample. In various embodiments, the fluid channel 213 may comprise an at least substantially hollow volume within the interior portion of the slide body 210 that is configured to receive at least a portion of a volume of fluid flowing through the fluid sampling cartridge 200 as the volume of fluid flows from the inlet tube 201 towards the outlet tube 202. The fluid channel 213 may be configured such that the at least a portion of the volume of fluid disposed (e.g., captured) therein may define a fluid sample that may remain within the fluid channel (e.g., within at least a portion thereof defining an imaging window) to facilitate execution of an imaging operation by a fluid sampling system while the fluid sampling cartridge 200 remains in an installed position within the housing thereof.

The slide body 210 of an exemplary fluid sampling cartridge 200 may further comprise an inlet conduit 214 defined by a hollow conduit within the interior of the slide body 210 that extends between the fluid channel 213 and a hollow channel 211B of the top portion 211 of the slide body 210. In various embodiments, the inlet conduit 214 may be configured such that the fluid channel 213 is fluidly connected to an open atmosphere via the inlet conduit 214. Further, in various embodiments, the slide body 210 may be configured such that upon the slide body 210 being connected to the inlet tube 201, the inlet conduit 214 facilitates a fluid connection between the inlet tube 201 and the fluid channel 213 to enable fluid flow from the inlet tube 201 into the fluid channel 213 via the inlet conduit 214. In such an exemplary configuration, a fluid sample defined by at least a portion of the fluid received by the slide body 210 from the inlet tube 201 may be delivered to the fluid channel 213 via the inlet conduit 214. For example, the inlet conduit 214 may have a first conduit end that is in fluid communication with the hollow channel 211B of the top portion 211 of the slide body 210 such that upon a volume of fluid being received by the fluid sampling cartridge 200 (e.g., via inlet tube 201), the volume of fluid may travel along a fluid flow path defined at least in part by the inlet conduit 214. Further, the inlet conduit 214 may have an opposing second conduit end that is in fluid communication with the fluid channel 213 such that upon travelling along a portion of the fluid flow path defined by the length of the inlet conduit 214, the volume of fluid may flow into the fluid channel 213.

In various embodiments, at least a portion of the volume of fluid engaged with and/or provided at least substantially adjacent to the second conduit end of the inlet conduit 214 may be diverted into, absorbed by, and/or otherwise received within the interior volume defined by the fluid channel 213 as part of a fluid sample capture operation. In various embodiments, the fluid sample may be diverted into, absorbed by, and/or otherwise received within the fluid channel 213 via a capillary effect and/or a capillary action (e.g., via an at least substantially small opening defined at the second conduit end) so as to define a fluid sample captured by and/or disposed within the fluid channel 213. The terms “capillary effect” and “capillary action” refer to the ability of a fluid channel 213 to draw fluid to flow or expand through part(s) or all of the fluid channel 213 without the assistance of (or, in some examples, even in opposition to) an external force. In various embodiments, at least substantially all of the volume of fluid received within the inlet conduit 214 may be dispensed into fluid channel 213 such that as the fluid sampling cartridge 200 begins to receive the volume of fluid from an inlet tube 201 connected thereto, the interior volume of the fluid channel 213 becomes filled with at least a portion of the volume of fluid (e.g., a fluid sample).

As illustrated, the slide body 210 of an exemplary fluid sampling cartridge 200 may further comprise an outlet conduit 215 defined by a hollow conduit within the interior of the slide body 210 that extends between the fluid channel 213 and a hollow channel 211B of the top portion 211 of the slide body 210. In various embodiments, the outlet conduit 215 may be configured such that the fluid channel 213 is fluidly connected to an open atmosphere via the outlet conduit 215. In various embodiments, the outlet conduit 215 may have an at least substantially similar configuration to the inlet conduit 214 of the slide body 210. Further, in various embodiments, the slide body 210 may be configured such that upon the slide body 210 being connected to an inlet tube 201 and an outlet tube 202, the outlet conduit 215 facilitates a fluid connection between the fluid channel 213 and the outlet tube 202 to enable fluid flow from the fluid channel 213 into the outlet tube 202 via the outlet conduit 215.

In such an exemplary configuration, the outlet conduit 215 may have a first conduit end that is in fluid communication with the fluid channel 213 such that upon the fluid channel 213 being filled with fluid from the volume of fluid received within the fluid sampling cartridge 200, at least a portion of the fluid disposed within the fluid channel 213 may be dispensed into the outlet conduit 215 (e.g., via the first conduit end thereof). The outlet conduit 215 may be configured such that a portion of the volume of fluid received within by the fluid sampling cartridge 200 (e.g., an overflow portion) that flows into the outlet conduit 215 via the first conduit end thereof may further travel along a portion of the fluid flow path defined by the length of the outlet conduit 215 towards an opposing second conduit end thereof, which may be fluidly connected with an open atmosphere and/or the hollow channel 211B of the top portion 211 of the slide body 210. Upon traveling along the length of the outlet conduit 215, the volume of fluid disposed within the outlet conduit 215 may be dispensed into the hollow channel 211B and/or into the outlet tube 202 connected thereto (e.g., via the second conduit end of the outlet conduit 215).

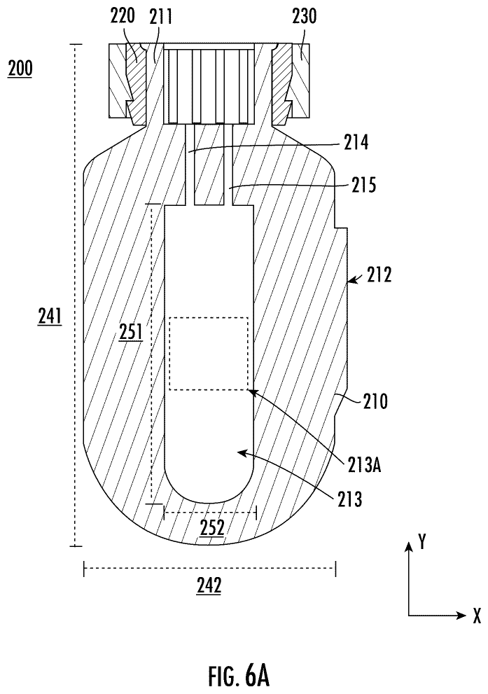

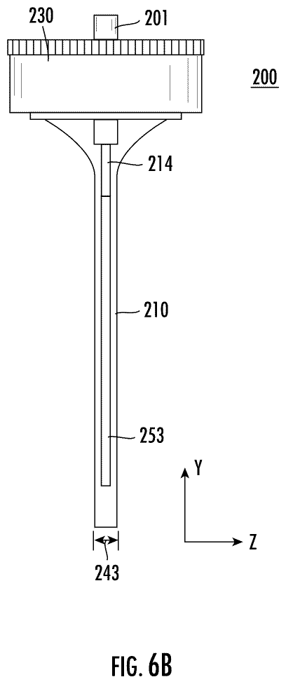

As a non-limiting example provided for illustrative purposes, FIGS. 6A and 6B illustrate a front view and a side view, respectively, of an exemplary fluid sampling cartridge 200. In various embodiments, as illustrated in FIGS. 6A and 6B, the fluid channel 213 defined within an interior portion of the slide body 210 may be defined at least in part by a fluid channel length 251 defined in a length direction (e.g., in a y-direction as defined in the exemplary embodiment illustrated in FIGS. 6A and 6B). Further, in various embodiments, as illustrated in FIG. 6A, the fluid channel 213 may be further defined by a fluid channel width 252 defined in a width direction perpendicular to the length direction (e.g., in an x-direction as defined in the exemplary embodiment illustrated in FIG. 6A). Further still, in various embodiments, as illustrated in FIG. 6B, the fluid channel 213 may be further defined by a fluid channel thickness 253 defined in a thickness direction perpendicular to both the length and width directions (e.g., in a z-direction as defined in the exemplary embodiment illustrated in FIG. 6B).

In various embodiments, the fluid channel length 251 of a fluid channel 213 of an exemplary fluid sampling cartridge 200 may be at least approximately between 5 mm and 50 mm (e.g., between 20 mm and 35 mm). As an illustrative example, the fluid channel length 251 of the fluid channel 213 may be at least approximately 50 mm. Further, in various embodiments, the fluid channel width 252 of a fluid channel 213 of an exemplary fluid sampling cartridge 200 may be at least approximately between 5 mm and 15 mm (e.g., between 8 mm and 12 mm). As an illustrative example, the fluid channel width 252 of the fluid channel 213 may be at least approximately 10 mm. Further, in various embodiments, the fluid channel thickness 253 of a fluid channel 213 of an exemplary fluid sampling cartridge 200 may be at least approximately between 0.2 mm and 2.0 mm (e.g., between 0.2 mm and 0.4 mm). As an illustrative example, the fluid channel thickness 253 of the fluid channel 213 may be at least approximately 0.3 mm. In various embodiments, an exemplary fluid sampling cartridge 200 may comprise a fluid channel 213 having an interior volume defined at least in part by the fluid channel length 251, the fluid channel width 252, and the fluid channel thickness 253 thereof. As a non-limiting example, in various embodiments, the interior volume of an exemplary fluid channel 213 may be at least approximately between 5 mm³ and 1500 mm³.

Further, as illustrated in FIGS. 6A and 6B, the slide body 210 of an exemplary fluid sampling cartridge 200 may be defined at least in part by a slide body length 241 defined in a length direction (e.g., in a y-direction as defined in the exemplary embodiment illustrated in FIGS. 6A and 6B). Further, in various embodiments, as illustrated in FIG. 6A, the slide body 210 may be further defined by a slide body width 242 defined in a width direction perpendicular to the length direction (e.g., in an x-direction as defined in the exemplary embodiment illustrated in FIG. 6A). Further still, in various embodiments, as illustrated in FIG. 6B, the slide body 210 may be further defined by a slide body thickness 243 defined in a thickness direction perpendicular to both the length and width directions (e.g., in a z-direction as defined in the exemplary embodiment illustrated in FIG. 6B).

In various embodiments, the slide body length 241 of the slide body 210 of an exemplary fluid sampling cartridge 200 may be at least approximately between 40 mm and 75 mm (e.g., between 50 mm and 65 mm). As an illustrative example, the slide body length 241 of the fluid channel 213 may be at least approximately 75 mm. Further, in various embodiments, the slide body width 242 of the slide body 210 of an exemplary fluid sampling cartridge 200 may be at least approximately between 10 mm and 50 mm (e.g., between 25 mm and 35 mm). As an illustrative example, the slide body width 242 of the slide body 210 may be at least approximately 50 mm. Further, in various embodiments, the slide body thickness 243 of a slide body 210 of an exemplary fluid sampling cartridge 200 may be at least approximately between 1.5 mm and 3.5 mm (e.g., between 2.0 mm and 3.0 mm). As an illustrative example, the fluid channel thickness 253 of the fluid channel 213 may be at least approximately 1.5 mm.

In various embodiments, an exemplary fluid sampling cartridge 200 may be configured such that upon being secured in an installed position within the housing of a fluid sampling system (e.g., fluid sampling system 10, as illustrated in FIG. 1), at least a portion of the fluid channel 213 is arranged within the field of view of an imaging device of the fluid sampling system such that the imagining device may capture one or more images and/or generate image data of the at least a portion of the fluid sample captured within the fluid channel 213 that is disposed within the field of view of the imaging device. For example, as illustrated in FIG. 6A, the fluid sampling cartridge 200 may be configured such that a portion of the fluid channel 213 defining a receiving area 213A intersects a line of sight of the imaging device of the fluid sampling system and a portion of the fluid sample that is captured within the receiving area 213A of the fluid channel 213 is arranged a field of view of the imaging device. As described herein, the slide body 210 may be made of an at least substantially transparent material to facilitate a light beam emitted from an exemplary illumination source to pass through the fluid sample captured within the receiving area 213A of the fluid channel 213 and/or enable an image to be taken of the portion of the fluid sample captured within the receiving area 213A. The portion of the fluid sample disposed within the receiving area 213A may be visible within the field of view of the imaging device such that the imaging device may capture an image of the portion of the fluid sample disposed within the receiving area 213A, as described herein. Such an exemplary configuration may be utilized to facilitate execution of at least a portion of a fluid sample analysis operation to determine one or more fluid characteristics of the fluid sample captured within the fluid channel 213.

With reference back to the example embodiment illustrated in FIG. 5, the slide body 210 of an exemplary fluid sampling cartridge 200 may further comprise one or more alignment features, support features, and/or the like configured to engage at least a portion of a fluid sampling cartridge engagement dock defined by the housing of an exemplary fluid sampling system to maintain a desired positioning of the fluid sampling cartridge 200 in the installed position relative to the housing and/or the imaging device of the fluid sampling system. As a non-limiting example, the exemplary fluid sampling cartridge 200 illustrated in FIG. 5 comprises an alignment rail 212 provided along at least a portion of an exterior side edge of the slide body 210. The alignment rail 212 may be configured to fit within an alignment channel defined by the fluid sampling cartridge engagement dock to restrict the movement of the fluid sampling cartridge 200 relative to the housing 100 in one or more linear and/or rotational directions. In various embodiments, the alignment rail 212 defined by the slide body 210 may allow for the vertical movement of the fluid sampling cartridge 200 into and/or out of the fluid sampling cartridge engagement dock in one or more vertical directions, such that the alignment rail 212 ensures a proper alignment of the slide body 210 within the fluid sampling cartridge engagement dock as the fluid sampling cartridge 200 is being lowered into the installed position.

In various embodiments, as illustrated, the slide body 210 may have an asymmetric configuration wherein the alignment rail 212 is provided along a first exterior side edge of the slide body 210, while an opposing exterior side edge of the slide body 210 defines an at least substantially different alignment feature and/or is void of any alignment features. For example, in an exemplary configuration wherein the fluid sampling cartridge engagement dock defines a corresponding alignment slot along only a singe location along a perimeter of the receiving orifice thereof, the fluid sampling cartridge 212 having an asymmetric configuration with the alignment rail 212 along only one side of the slide body 210 may ensure that upon being inserted into the receiving orifice of the fluid sampling cartridge engagement dock, the fluid sampling cartridge 200 is positioned in a proper orientation (e.g., rotational, linear, and/or a combination thereof) relative to the imaging device of the fluid sampling system.

In various embodiments, a fluid sampling cartridge 200 may further comprise a body holder 220 configured to engage at least a portion of each of the slide body 210 and the cartridge locator 230 to at least partially secure the cartridge locator 230 relative to the slide body 210 in one or more directions. For example, in various embodiments, the body holder 220 comprises an at least substantially tubular configuration defined by a cylindrical sidewall 220A and an interior channel 220B provided therethrough such that the sidewall 220A has a thickness defined radially between an exterior surface of the sidewall 220A and an interior surface thereof that defines the perimeter of the interior channel 220B. In various embodiments, the body holder 220 of an exemplary fluid sampling cartridge 200 may be made of an at least partially flexible material. As a non-limiting example, in various embodiments, an example body holder 220 may be made of an at least partially flexible material having a shore A hardness of at least approximately between 50 and 60. As an illustrative example, the at least partially flexible material from which the body holder 220 is made may have a shore A hardness of at least approximately 50.

In various embodiments, the body holder 220 may be configured to engage the slide body 210 at an exterior surface of the top portion 211. For example, the body holder 220 may be assembled relative to the top portion 211 of the slide body 210 by arranging the top portion 211 within the interior channel 220B defined by the body holder 220. In various embodiments, the body holder 220 may be configured such that at least substantially the entirety of the exterior perimeter surface of top portion 211 of the slide body 210 may be physically abutted against an interior surface of the cylindrical sidewall 220A. The fluid sampling cartridge 200 may be configured such that upon the body holder 220 being assembled relative to the slide body 210 (e.g., the top portion 211), the body holder 220 and the top portion 211 are coaxially arranged such that respective central axes defined by the interior channel 220B and the hollow channel 211B are coaxially aligned. Further, upon the body holder 220 being assembled relative to the slide body 210 (e.g., the top portion 211), the body holder 220 and the top portion 211 of the slide body 210 are secured relative to one another such that the body holder 220 is at least substantially prevented from moving linearly and/or rotationally relative to the slide body 210. In various embodiments, the body holder 220 may be configured to be assembled relative to the top portion 211 of the slide body 210 such that the body holder 220 is prevented from moving relative to the top portion 211 of the slide body 210 in each of the x-, y-, and z-directions, as defined in the exemplary embodiment illustrated in FIG. 5, as well as in each of a first rotational direction and an opposing second rotational direction defined about the coaxial central axes of the body holder 220 and the top portion 211 oriented along a y-axis, as defined in the exemplary embodiment illustrated in FIG. 5.

In various embodiments, an example fluid sampling cartridge 200 may further comprise a cartridge locator 230 configured for physical engagement with at least a portion of the fluid sampling system housing and/or the fluid sampling cartridge engagement dock defined therein to at least partially align the fluid sampling cartridge 200 within the fluid sampling cartridge engagement dock and enable the replaceable configuration of the fluid sampling cartridge 200 by facilitating the selective configuration thereof (e.g., via user engagement) between a locked and an unlocked configuration within the housing of a fluid sampling system. In various embodiments, the cartridge locator 230 may comprise an at least substantially tubular configuration defined by a cylindrical sidewall 231 and an interior channel 232 provided therethrough such that the sidewall 231 has a thickness defined radially between an exterior surface of the sidewall 231 and an interior surface thereof that defines the perimeter of the interior channel 232. As illustrated, the at least substantially tubular configuration of the exemplary cartridge locator 230 may be defined at least in part by a cartridge locator length defined in a length direction (e.g., in a y-direction as defined in the exemplary embodiment illustrated in FIG. 5) between a bottom edge 230B and a top edge 230A of the cartridge locator 230 (e.g., of the sidewall 231).

In various embodiments, the cartridge locator 230 of an exemplary fluid sampling cartridge 200 may be made of an at least substantially rigid material. As a non-limiting example, in various embodiments, an example cartridge locator 230 may be made of an at least substantially rigid material having a shore D hardness of at least approximately between 50 and 80. As a further illustrative example, in various embodiments, the at least substantially rigid material from which the cartridge locator 230 is made may have a shore D hardness of at least approximately 80.

Further, in various embodiments, the body holder 220 may be configured to define a dynamic engagement with the cartridge locator 230 to at least partially secure the cartridge locator 230 relative to the slide body 210 (e.g., the top portion 211). In various embodiments, the body holder 220 and cartridge locator 230 of an example fluid sampling cartridge 200 may be configured to be assembled relative to one another via a press-fit operation defined by the cartridge locator 230 (e.g., an interior surface thereof) being press-fit into a physical engagement with at least a portion of the exterior surface of the sidewall 220A of the body holder 220 such that the at least substantially tubular cartridge locator 230 is disposed radially outside of the body holder 220, surrounding the exterior surface of the sidewall 220A of the body holder 220. As illustrated, in various embodiments, the body holder 220 may be configured for arrangement within an internal channel 231 of the cartridge locator 230 such that at least a portion of the exterior surface of the sidewall 220A of the body holder 220 is arranged at least substantially adjacent an interior surface of the at least substantially tubular cartridge locator 230. In such an exemplary configuration, upon the fluid sampling cartridge 200 being assembled in an assembled configuration, each of the top portion 211 of the slide body 210, the body holder 220, and the cartridge locator 230 are coaxially arranged, with respective central axes thereof being at least substantially aligned and the body holder 220 being positioned radially in between the top portion 211 of the slide body 210 and the cartridge locator 230.

In various embodiments, one or more sets of corresponding geometric features may be defined along the exterior surface of the sidewall 220A of the body holder 220 and the interior surface of the interior channel 232 of the cartridge locator 230, respectively, to facilitate engagement between the two components during the assembly relative to one another. For example, in various embodiments, the body holder 220 may comprise one or more exterior engagement ledge 221 protruding in an outward radial direction from the exterior surface of the sidewall 220A and being disposed along at least a portion of the perimeter (e.g., the entirety of the perimeter) thereof. Further, in various embodiments, the cartridge locator 230 may comprise one or more interior engagement ledge (not shown) protruding in an inward radial direction from the interior surface of the sidewall 231 into the interior channel 232 along at least a portion of the inner perimeter (e.g., the entirety of the inner perimeter) thereof.

Upon the at least partially flexible body holder 220 being pressed into the interior channel 232 of the at least substantially rigid cartridge locator 230, the corresponding geometric features of the respective components may physically abut one another to secure the relative position of the body holder 220 and the cartridge locator 230 in one or more linear directions. For example, the fluid sampling cartridge 200 may be configured such that the exterior engagement ledge 221 of the body holder 220 may engage the corresponding interior engagement ledge of the cartridge locator 230 during the press-fit assembly operation and such that the interior engagement ledge may slide over the exterior engagement ledge 221 as the body holder 220 being positioned within the interior channel 232 of the cartridge locator 230, but upon the body holder 220 reaching the assembled position, the exterior engagement ledge 221 and the interior engagement ledge of the body holder 220 and the cartridge locator 230, respectively, may embody physical obstacles configured to physically abut one another to prevent the body holder 220 from being removed from within the cartridge locator 230.

An example fluid sampling cartridge 200 may be configured such that a dynamic engagement of the body holder 220 relative to the cartridge locator 230 is defined by the body holder 220 being at least partially secured relative to the cartridge locator 230 to prevent the relative linear movement between the cartridge locator 230 and the body holder 220 in both the x- and y-directions, as defined in the exemplary embodiment illustrated in FIG. 5, while enabling the cartridge locator 230 to rotate in one or more directions (e.g., in each of a first rotational direction and an opposing second rotational direction) defined about the coaxial central axes 230C of the body holder 220 and the cartridge locator 230 oriented along the y-axis. Further, as described in additional herein, the dynamic engagement of the body holder 220 relative to the cartridge locator 230 may be further defined by the body holder 220 being at least partially secured relative to the cartridge locator 230 to allow for an at least substantially minimized linear movement of the cartridge locator 230 relative to the body holder 220 in the z-direction, as defined in the exemplary embodiment illustrated in FIG. 5, based at least in part on biasing force(s) imparted on the cartridge locator 230 from a biasing plunger as the fluid sampling cartridge 200 is being installed in and/or removed from the installed position.

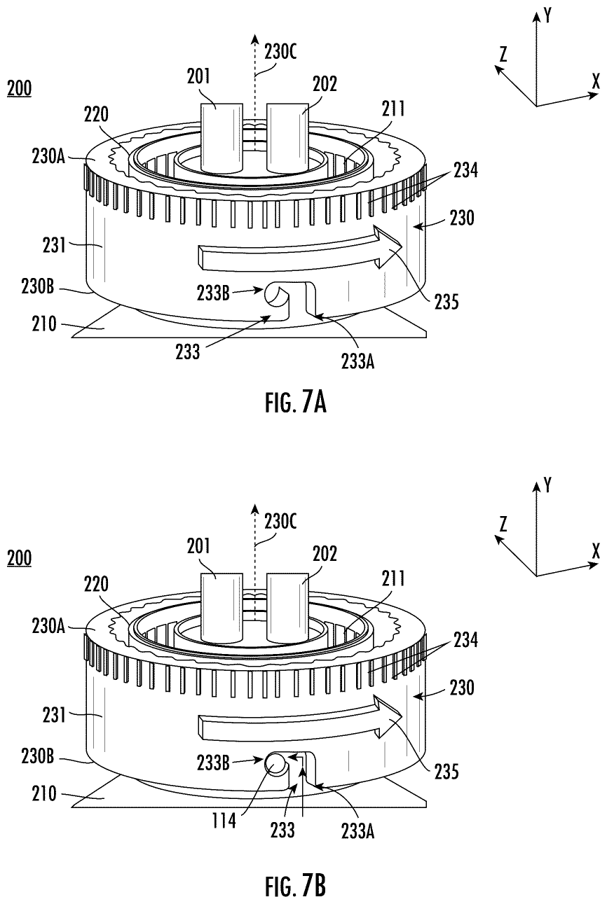

As described herein, the cartridge locator 230 may be configured such that the user engagement required to handle the fluid sampling cartridge 200 and operate the fluid sampling system is limited to user engagement with the cartridge locator 230. As described herein, an exemplary fluid sampling system may be configured such that a fluid sampling cartridge 200 may be inserted by a user through a receiving opening defined by the housing of the fluid sampling system such that the fluid sampling cartridge 200 physically engages at least a portion of a fluid sampling cartridge engagement dock defined by the housing to facilitate an arrangement of the fluid sampling cartridge 200 in the installed position. In various embodiments, the cartridge locator 230 may be configured to engage one or more surfaces, features, and/or components defined within the fluid sampling cartridge engagement dock as the fluid sampling cartridge 200 is being inserted by a user into the housing of the fluid sampling system. In various embodiments, an exemplary cartridge locator 230 may comprise a locking pin slot 233 defined within the sidewall 231 and configured for receiving a locking pin defined by the fluid sampling cartridge engagement dock therein as the cartridge locator 230 is being inserted towards the installed position within the housing of the fluid sampling system. As a non-limiting example, FIGS. 7A and 7B illustrate perspective views of an example fluid sampling cartridge provided in an unlocked configuration and a locked configuration, respectively, relative to a locking pin defined by a fluid sampling cartridge engagement dock of a fluid sampling system, in accordance with various embodiments described herein. In particular, FIG. 7A illustrates an exemplary fluid sampling cartridge 200 in an unlocked configuration defined at least in part by the locking pin slot 233 being without a locking pin disposed therein. The exemplary fluid sampling cartridge 200 illustrated in FIG. 7A is shown in an unlocked configuration defined by the lack of a locking pin within the locking pin slot 233 of the cartridge locator 230 such that the cartridge locator 230 would be at least partially unsecured relative to fluid sampling cartridge engagement dock and thus, able to move linearly (e.g., in a removal direction out of the fluid sampling cartridge engagement dock) and/or rotationally in one or more directions relative to the housing of the fluid sampling system.

FIG. 7B illustrates the exemplary fluid sampling cartridge 200 in a locked configuration that is defined at least in part by the locking pin slot 233 having a locking pin 114 defined of the fluid sampling cartridge engagement dock being disposed within the locking pin slot 233 of the cartridge locator 230 along the slot length thereof (e.g., at the pin retention end 233B). As illustrated, the locking pin slot 233 of an example cartridge locator 230 may extend from a slot opening 233A defined at the bottom edge 230B of the cartridge locator 230 along a multi-directional slot length defined in a plurality of linear directions to a pin retention end 233B defined at the opposing end of the locking pin slot 233. For example, as illustrated, a first portion of the locking pin slot 233 may extend from the slot opening 233A defined at the bottom edge 230B of the cartridge locator 230 in a first direction at least substantially toward the top edge 230A of the cartridge locator 230 (e.g., in the positive y-direction as defined in the example embodiment illustrated in FIGS. 7A and 7B). In various embodiments, the first direction may be oriented at least substantially perpendicularly to the bottom edge 230B of the cartridge locator 230. Further, in various embodiments, a second portion of the locking pin slot 233 may extend from the end of the first portion of the locking pin slot 233 in a second direction at least substantially parallel with the top edge 230A of the cartridge locator 230 (e.g., in the negative x-direction as defined in the example embodiment illustrated in FIGS. 7A and 7B). In various embodiments, the second direction may be oriented at least substantially perpendicular to the first direction defined by the first portion of the locking pin slot 233. In various embodiments, the pin retention end 233B of the locking pin slot 233 may be defined at the end of the second portion of the locking pin slot 233. The pin retention end 233B may be defined at least in part by a length that extends from the end of the second portion of the locking pin slot 233 in a third direction that is at least substantially opposite the first direction defined by the first portion of the locking in slot 233, such as, for example, at least substantially toward the bottom edge 230B of the cartridge locator 230 (e.g., in the negative y-direction as defined in the example embodiment illustrated in FIGS. 7A and 7B).

As described herein, the fluid sampling cartridge engagement dock of an exemplary fluid sampling system may comprise an at least substantially rigid locking pin 114 configured to protrude perpendicularly from an interior sidewall of the fluid sampling cartridge engagement dock in an inward radial direction. As a fluid sampling cartridge 200 is being lowered into the fluid sampling cartridge engagement dock of the housing of a fluid sampling system (e.g., in a negative y-direction, as defined in the exemplary embodiment illustrated in FIGS. 2A and 2B), the cartridge locator 230 may be rotationally oriented within the fluid sampling cartridge engagement dock such that the slot opening 233A of the locking pin slot 233 is at least substantially aligned with the locking pin 114 of the fluid sampling cartridge engagement dock. As the fluid sampling cartridge is further inserted into the housing of the fluid sampling system, the locking pin 114 defined by the fluid sampling cartridge engagement dock is received within the locking pin slot 233 and positioned along the slot length thereof. Upon the locking pin 114 being disposed within the locking pin slot 233 of the cartridge locator 230, the locking pin may physically abut one or more surfaces of the locking pin slot 233 so as to at least partially restrict the cartridge locator 230 of the fluid sampling cartridge 200 from moving in one or more directions relative to the housing (e.g., the fluid sampling cartridge engagement dock) of the fluid sampling system.

In various embodiments, the fluid sampling cartridge 200 may be configured such that the dynamic engagement between the cartridge locator 230 and the body holder 220 enables the cartridge locator 230 to be rotated (e.g., by user engagement therewith) about a central axis 230C thereof relative to the locking pin 114 and/or the body holder 220 to arrange the fluid sampling cartridge 200 in a locked configuration within the fluid sampling cartridge engagement dock. The fluid sampling cartridge 200 may be configured such that the cartridge locator 230 may rotate about the central axis 230C without the body holder 220 and/or the slide body 210 secured thereto exhibiting any significant rotational movement within the internal portion of the housing of the fluid sampling system. Such a dynamic engagement of the cartridge locator 230 and the body holder 220 enables the fluid sampling cartridge 200 to be secured in a locked configuration without affecting the arrangement slide body 210 relative to the housing of the fluid sampling system.

In various embodiments, the cartridge locator 230 of an exemplary fluid sampling cartridge 200 may comprise one or more haptic elements defined along an exterior surface of the cartridge locator 230 configured to facilitate user interaction with the fluid sampling cartridge 200. In various embodiments, an exemplary cartridge locator 230 may comprise grip elements 234 and one or more haptic indicators 235. The grip elements 234 may be defined by raised portions along the exterior of the cartridge locator 230 that may facilitate an improved grip for a user engaging with the cartridge locator 230, such as, for example, as the user rotates the cartridge locator 230 within the housing of a fluid sampling system. The grip elements 234 are disposed at least substantially adjacent the top edge 230A of the cartridge locator 230 such that a user engagement therewith does not require user engagement with the slide body 210 of the fluid sampling cartridge 200. Such a configuration mitigates the need for user interaction with the slide body 210 and thus, facilitates a mitigated risk of sample contamination and/or inaccuracy caused by fingerprint impressions and/or other contaminations being left on the slide body 210, thereby increasing the accuracy of the fluid sampling system.

Further, in various embodiments, a cartridge locator 230 may comprise one or more haptic indicators defined along the exterior surface thereof that are configured to relay one or more operating instructions associated with the fluid sampling cartridge 200 to a user via the user's sense of touch. For example, the cartridge locator 230 comprises a haptic indicator 235 that is defined by a raised portion of the cartridge locator protruding from the exterior surface of the cartridge locator such that the haptic indicator may be felt by a user, such as, for example, a visually impaired user, upon the user touching the exterior of the cartridge locator. For example, the haptic indicator 235 may be configured to define a particular shape corresponding to one or more instructions that may be recognized by the user in order to relay to the user an appropriate cartridge orientation and/or instruction for configuring the cartridge within the housing of a fluid sampling system to facilitate operation thereof. As a non-limiting example, the exemplary cartridge locator 230 illustrated in FIGS. 7A and 7B comprises a haptic indicator 235 defined by an arrow indicating a direction of rotation corresponding to the rotational direction in which the cartridge locator 230 needs to be rotated to move the fluid sampling cartridge 200 into the locked configuration.

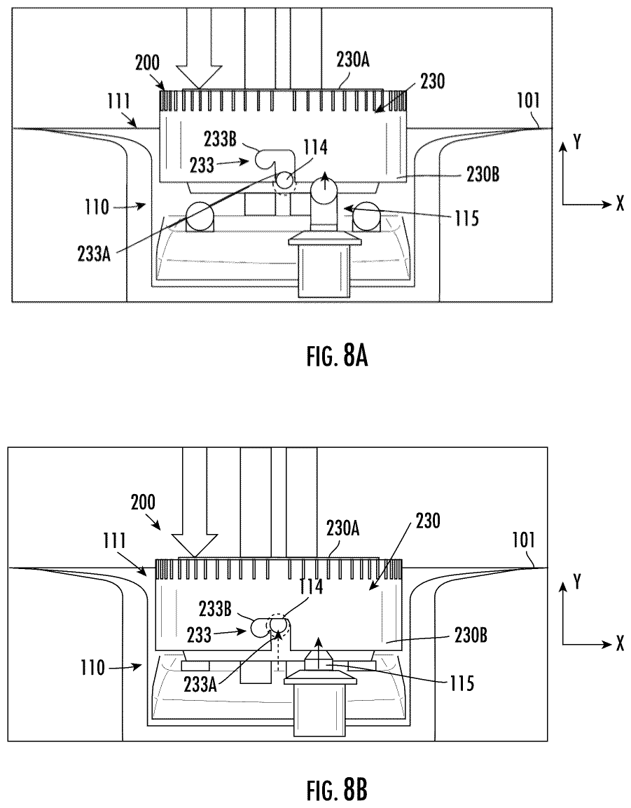

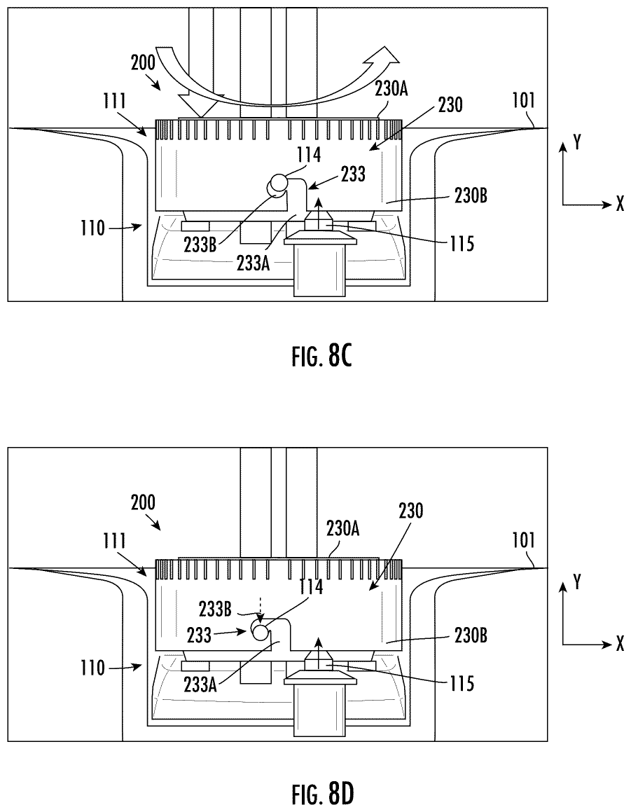

In various embodiments, an exemplary fluid sampling system may be configured such that based at least in part on the multi-directional configuration of the locking pin slot 233, a dual-action operation defined by one or more rotations and/or one or more linear movements of the cartridge locator 230 relative to the fluid sampling cartridge engagement dock (e.g., the locking pin) are required in order for the locking pin to be moved from the slot opening 233A to the pin retention end 233B. In various embodiments, an exemplary fluid sampling system may be configured such that inserting the replaceable fluid sampling cartridge into an installed position within the fluid sampling cartridge engagement dock of the fluid sampling system housing may be defined by the selective arrangement of a fluid sampling cartridge from an unlocked configuration to a locked configuration, which may be defined by a dual-action, multi-directional user interaction with a fluid sampling cartridge that causes a cartridge locator of the fluid sampling cartridge to be moved and/or rotated within the receiving orifice of the fluid sampling cartridge to secure the fluid sampling cartridge in the locked configuration. As an illustrative example, FIGS. 8A-8D illustrate various cross-sectional views of an exemplary fluid sampling system in accordance with various embodiments described herein. In particular, FIGS. 8A-8D illustrate an exemplary fluid sampling cartridge 200 being reconfigured from an unlocked configuration to a locked configuration as a result of a multi-directional, dual action user interaction with the cartridge locator 230 of the fluid sampling cartridge 200. For example, FIG. 8A illustrates the fluid sampling cartridge 200 being inserted into the receiving orifice 111 of the fluid sampling cartridge engagement dock 110 and arranged such that the locking pin 114 defined by the fluid sampling cartridge engagement dock 110 is provided at least substantially adjacent the slot opening 233A of the locking pin slot 233 defined by the cartridge locator 230 of the fluid sampling cartridge 200. As illustrated, the biasing plunger 115 of the fluid sampling cartridge engagement dock 110 may be in a default extended position defined by the biasing plunger, prior to any physical engagement with a fluid sampling cartridge 200 (e.g., with a cartridge locator 230) being extended from the recessed shelf of the receiving orifice as a result of the one or more biasing forces acting thereon.

As illustrated in FIG. 8B, a pushing force may cause the cartridge locator 230 to further move in a downward linear direction (e.g., in the negative y-direction as defined in the exemplary orientation illustrated in FIG. 8B) relative to the body holder of the fluid sampling cartridge 200 and the locking pin 114 defined by the fluid sampling cartridge engagement dock 110 (e.g., into the receiving orifice 111). In various embodiments, the force may be at least substantially opposite the biasing force defined by the one or more biasing plungers 115. For example, the force may be a pushing force that embodies a counterforce acting on the cartridge locator 230 in the opposite direction as the biasing force being applied to the cartridge locator 230 by the biasing plungers 115 disposed within the fluid sampling cartridge engagement dock 110. For example, the force may be of a magnitude greater than the biasing force from the plunger 115 such that a counterforce acting on the biasing plunger 115 from a surface of the cartridge locator 230 engaged with the biasing plunger 115 (e.g., bottom surface 230B) may cause the biasing plunger 115 to retract from the extended state in a direction towards the recessed shelf of the receiving orifice 111 to an at least partially compressed state. As the force causes the cartridge locator 230 to move in a downward direction within the receiving orifice 111 defined by the fluid sampling cartridge engagement dock 110 and the biasing plungers 115 to retract from the extended position, the locking pin 114 be received in the locking pin slot 233 via the slot opening 233A and move in a first direction (e.g., in the positive y-direction as defined in the exemplary orientation illustrated in FIG. 8B) along a first linear portion of the 233.

The locking pin slot 233 defined by the cartridge locator 230 of the fluid sampling cartridge 200 may be configured such that, upon such a pushing counterforce being applied to the cartridge locator 230 by a user, the locking pin 114 may move along the first portion of the locking pin slot 233 at least substantially toward a second portion of the locking pin slot 233, such that the locking pin 114 is arranged at a location at the end of the first portion of the locking pin slot 233 where the locking pin 114 may move into the second portion of the locking pin slot 233 upon a further rotation of the cartridge locator 230 relative to the fluid sampling cartridge engagement dock of the fluid sampling system.

As illustrated in FIG. 8C, a rotational force may be applied to the cartridge locator 230 (e.g., via user engagement therewith) that may cause the cartridge locator 230 to further move relative to the body holder of the fluid sampling cartridge 200 and the locking pin 114 defined by the fluid sampling cartridge engagement dock 110 in a rotational direction (e.g., in the counterclockwise direction as defined in the exemplary orientation illustrated in FIG. 8C). In various embodiments, the locking pin slot 233 defined by the cartridge locator 230 of the fluid sampling cartridge 200 may be configured such that, upon such a rotational force being applied to the cartridge locator 230 by a user, the locking pin 114 may move along the second portion of the locking pin slot 233 at least substantially toward a pin retention end 233B of the locking pin slot 233, such that the locking pin 114 is arranged at a location at the end of the second portion of the locking pin slot 233 where the locking pin 114 may move into the pin retention end 233B of the locking pin slot 233 upon a user disengagement of the cartridge locator 230.

For F example, as illustrated in FIG. 8D, an exemplary locking pin slot 233 may be configured such that a user disengagement of the cartridge locator 230 may remove the pushing counterforce describe in reference to FIGS. 8A and 8B as counteracting the biasing forces being applied to the cartridge locator in the upward direction. Accordingly, upon such a user disengagement, the biased configuration of the fluid sampling cartridge 200 engaged with the biasing plungers 115 causes the cartridge locator 230 to be pushed in at least substantially upward direction (e.g., in the positive y-direction direction as defined in the exemplary orientation illustrated in FIG. 8D) relative to the body holder of the fluid sampling cartridge 200 and the locking pin 114 defined by the fluid sampling cartridge engagement dock 110. Such a movement of the cartridge locator 230 relative to the locking pin 114 may cause the locking pin 114 to be received within the pin retention end 233B of the locking pin slot 233, where it may be restricted from becoming dislodged until a subsequent user engagement with the cartridge locator as part of an unlocking operation (e.g., as selective rearrangement of the cartridge locator from a locked configuration to an unlocked configuration), as described herein.

In various embodiments, the pin retention end 233B may be configured to receive a locking pin 114 as the cartridge locator 230 is being rotated about a central axis 230C thereof relative to the fluid sampling cartridge engagement dock of the fluid sampling system (e.g., in a counterclockwise direction about central axis 230C as defined in the example embodiment illustrated in FIGS. 7A and 7B). The pin retention end 233B may be configured to extend at least partially in the third direction opposite the first direction defined by the first portion of the locking pin slot 233 such that, upon the locking pin 114 being received therein, an upward biasing force being imparted on the cartridge locator 230 (e.g., a bottom edge 230B of the cartridge locator 230) from a biasing plunger defined within the fluid sampling cartridge engagement dock in a direction at least substantially parallel with the central axis 230C of the cartridge locator 230 (e.g., in the positive y-direction as defined in the example embodiment illustrated in FIGS. 7A and 7B) may cause a corresponding upward linear movement of the cartridge locator 230 relative to the locking pin 114, such that the locking pin 114 becomes arranged in a bottom end of the pin retention end 233B of the locking pin slot 233.

In various embodiments, the locking pin 114 being disposed within the pin retention end 233B of the locking pin slot 233 may secure the fluid sampling cartridge in a locked configuration within the housing (e.g., the fluid sampling cartridge engagement dock) of the fluid sampling system. The pin retention end 233B of the locking pin slot 233 may be configured to receive a locking pin traveling along the locking pin slot 233 therein and prevent the locking pin therein from retracting out of the pin retention end 233B unless a user engages the cartridge locator and executes a dual-action removal operation, as described herein. For example, the pin retention end 233B may be configured to define a physically obstacle that prevents the locking pin 114 from moving back out of the pin retention end 233B (e.g., and into the second portion of the locking pin slot 230 towards the slot opening 233A). As described in further detail herein, in order for the locking pin 114 to be removed from within the pin retention end 233B such that the fluid sampling cartridge 200 may be removed from the locked configuration, a downward force (e.g., a force in the negative y-direction as defined in the example embodiment illustrated in FIGS. 7A and 7B) greater than the biasing force of the biasing plunger must be applied to the cartridge locator 230 must be applied to the cartridge locator 230, such as, for example, via user engagement therewith at the top edge 230A) to overcome the biasing force and cause a corresponding downward linear movement of the cartridge locator 230 relative to the locking pin 114. The pin retention end 233B may be configured such that, upon such a pushing counterforce being applied to the cartridge locator 230 by a user, the locking pin 114 may move at least substantially toward the second portion of the locking pin slot 233 such that the locking pin 114 may move into the second portion of the locking pin slot 233 upon a further rotation of the cartridge locator 230 relative to the fluid sampling cartridge engagement dock of the fluid sampling system (e.g., in a clockwise direction about central axis 230C as defined in the example embodiment illustrated in FIGS. 7A and 7B).

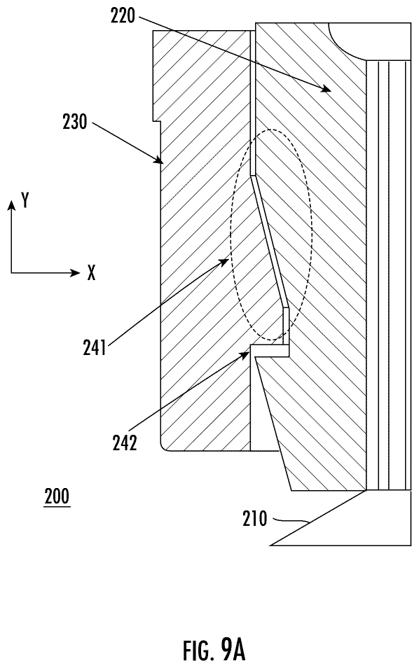

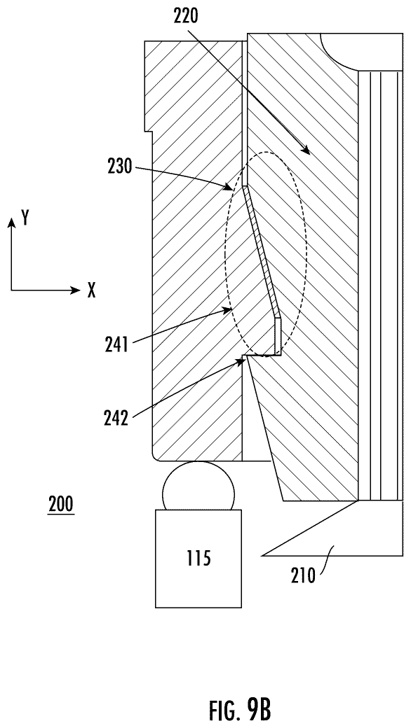

FIGS. 9A and 9B illustrate cross-sectional views of an exemplary fluid sampling system in accordance with various embodiments described herein. In particular, FIGS. 9A and 9B illustrate cross-sectional views of various components of an exemplary fluid sampling system in an uninstalled position and an installed position, respectively. As illustrated in FIG. 9A, an example fluid sampling cartridge 200 in an uninstalled position may be configured such that the body holder 220 and the cartridge locator 230 are defined by one or more separation gaps therebetween that enable the dynamic engagement therebetween. For example, a first separation gap 241 may be defined between an at least partially inward-facing interior surface of the cartridge locator 230 and an at least partially outward-facing adjacent portion of an exterior surface of the body holder 220 disposed therein. Further, in various embodiments, a second separation gap 242 may be defined between may be defined between an at least partially downward-facing interior surface of the cartridge locator 230 and an at least partially upward-facing adjacent portion of an exterior surface of the body holder 220 disposed therein. The one or more separation gaps may enable the cartridge locator 230 to be rotated about its central axis relative to the body holder 220 upon the fluid sampling cartridge 200 first engaging the fluid sampling cartridge engagement dock defined by the housing (e.g., as illustrated in FIGS. 8A-8C).

As illustrated in FIG. 9B, upon a user executing a dual action installation process to push and/or rotate the cartridge locator 230 relative to the fluid sampling cartridge engagement dock such that the locking pin is moved along the locking pin slot and into the pin retention end 233B, the pin retention end 233B may be configured such that the upward biasing force acting on the cartridge locator 230 causes the cartridge locator 230 to be linearly moved in a corresponding upward vertical direction relative to the body holder 220 (e.g., in the positive y-direction as defined in the exemplary embodiment illustrated in FIGS. 9A and 9B). As illustrated, the cartridge locator 230 may be moved in an upward direction until at least a portion of the cartridge locator 230 physically abuts an adjacent one or more portions of the exterior surface of the body holder 220, thereby at least substantially eliminating the one or more separation gaps 241, 242. Such a physical engagement of the cartridge locator 230 to the body holder 220 may prevent over force, operably prevent the cartridge locator 230 to the body holder 220 from moving relative to one another without any further user interaction therewith and enable the fluid sampling cartridge 200 to be properly locked within the installed position.

Many modifications and other embodiments of the inventions set forth herein will come to mind to one skilled in the art to which these inventions pertain having the benefit of teachings presented in the foregoing descriptions and the associated drawings. Although the figures only show certain components of the apparatus and systems described herein, it is understood that various other components may be used in conjunction with the system. Therefore, it is to be understood that the inventions are not to be limited to the specific embodiments disclosed and that modifications and other embodiments are intended to be included within the scope of the appended claims. Moreover, the steps in any method described above may not necessarily occur in the order depicted in the accompanying diagrams, and in some cases one or more of the steps depicted may occur substantially simultaneously, or additional steps may be involved. Although specific terms are employed herein, they are used in a generic and descriptive sense only and not for purposes of limitation.

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. Alternative embodiments that result from combining, integrating, and/or omitting features of the embodiment(s) are also within the scope of the disclosure. Accordingly, the scope of protection is not limited by the description set out above.

Additionally, the section headings used herein are provided for consistency with the suggestions under 37 C.F.R. 1.77 or to otherwise provide organizational cues. These headings shall not limit or characterize the invention(s) set out in any claims that may issue from this disclosure.

Use of broader terms such as “comprises,” “includes,” and “having” should be understood to provide support for narrower terms such as “consisting of,” “consisting essentially of,” and “comprised substantially of” Use of the terms “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

1. A fluid sampling cartridge for capturing a fluid sample, the fluid sampling cartridge comprising:
a slide body configured for receiving a fluid sample within a fluid channel defined within an interior of the slide body;
a cartridge locator configured for physical engagement with at least a portion of a housing defined by a fluid sampling system to at least partially align the fluid sampling cartridge in an installed position within the housing of the fluid sampling system; and,
a body holder secured relative to the slide body and configured to be dynamically engaged with the cartridge locator to at least partially secure the cartridge locator relative to the slide body in one or more direction, wherein dynamic engagement of the cartridge locator relative to the body holder is defined by the cartridge locator being configured to rotate in one or more directions about a central axis thereof relative to the body holder;
wherein the fluid sampling cartridge is configured to facilitate selective arrangement of the fluid sampling cartridge between a locked configuration and an unlocked configuration within the housing of the fluid sampling system based at least in part on one or more relative movements of the cartridge locator with respect to the body holder dynamically engaged therewith;
wherein the fluid sampling cartridge is configured for arrangement within the housing of the fluid sampling system in the installed position to facilitate execution of an imaging operation by the fluid sampling system with respect to the fluid sample captured in the fluid channel while the fluid sampling cartridge remains in the installed position within the housing.

2. The fluid sampling cartridge of claim 1, wherein the fluid sampling cartridge is configured for arrangement within a housing of a fluid sampling system such that the fluid sample captured within the fluid channel is disposed within a field of view of an imaging device disposed within the housing of the fluid sampling system.

3. The fluid sampling cartridge of claim 2, wherein the fluid sampling cartridge is configured to enable an imaging of the fluid sample captured within the fluid channel by the imaging device at an instance during operation of the fluid sampling system in which a volume of fluid is flowing through the fluid channel.

4. The fluid sampling cartridge of claim 1, wherein the fluid sampling cartridge is configured to facilitate the imaging of the fluid sample defined by the imaging device executing a digital holography imaging technique.

5. The fluid sampling cartridge of claim 1, wherein the fluid sampling cartridge is configured such that upon being arranged in the installed position, the cartridge locator is configured to physically engage one or more biasing plungers at a bottom surface of the cartridge locator to facilitate a securing of the fluid sampling cartridge in the installed position based at least in part on one or more biasing forces being applied thereto.

6. The fluid sampling cartridge of claim 1, wherein the body holder is made of an at least partially flexible material.

7. The fluid sampling cartridge of claim 1, wherein the cartridge locator is made of an at least substantially rigid material.

8. The fluid sampling cartridge of claim 1, wherein the slide body comprises one or more alignment rails provided along at least a portion of an exterior side edge of the slide body, the one or more alignment rails being configured to fit within an alignment channel defined by a fluid sampling cartridge engagement dock of the housing of the fluid sampling system to restrict the movement of the fluid sampling cartridge relative to the housing in one or more of a linear direction and a rotational direction.

9. The fluid sampling cartridge of claim 1, further comprising one or more haptic elements defined along an exterior surface of the cartridge locator configured to facilitate user interaction with the fluid sampling cartridge.

10. The fluid sampling cartridge of claim 1, wherein the fluid sampling cartridge is configured to be received within the housing of the fluid sampling system such that, upon being arranged in the installed position, at least a portion of the cartridge locator is accessible via a top side of the housing for user engagement therewith.

11. The fluid sampling cartridge of claim 1, wherein the selective adjustment of the fluid sampling cartridge between the locked configuration and the unlocked configuration is defined by a dual-action, multi-directional adjustment of the cartridge locator relative to the body holder that causes the cartridge locator to be moved relative to a locking pin defined within a fluid sampling cartridge engagement dock defined by the housing of the fluid sampling system.

12. The fluid sampling cartridge of claim 11, wherein the cartridge locator defines a locking pin slot configured to receive the locking pin defined by the housing of the fluid sampling system such that, upon the fluid sampling cartridge being arranged in the installed position, the locking pin restricts the fluid sampling cartridge from moving in one or more directions relative to the housing of the fluid sampling system.

13. The fluid sampling cartridge of claim 12, wherein the locking pin slot has a multi-directional configuration defined by a first portion extending from a slot opening in a first direction and a second portion extending from the first direction in a second direction to a slot retention end, wherein the first direction and the second direction are at least substantially different from one another.

14. The fluid sampling cartridge of claim 13, wherein the first direction and the second direction are at least substantially perpendicular to one another.

15. The fluid sampling cartridge of claim 13, wherein the fluid sampling cartridge is configured such that the locking pin defined by the fluid sampling system being moved from the slot opening to the pin retention end requires a linear movement of the cartridge locator relative to the body holder in a first linear direction and a rotational movement of the cartridge locator relative to the body holder in a first rotational direction.

16. The fluid sampling cartridge of claim 15, wherein the fluid sampling cartridge is configured such that the locking pin defined by the fluid sampling system being moved from the slot opening to the pin retention end further requires a second linear movement of the cartridge locator relative to the body holder in a second linear direction opposite the first linear direction.

17. The fluid sampling cartridge of claim 1, wherein the slide body is made of an at least substantially transparent material configured to facilitate a fluid imaging operation wherein the fluid sample captured within a fluid channel is imaged by an imaging device disposed within the housing of the fluid sampling system.

18. The fluid sampling cartridge of claim 1, further comprising an inlet conduit through which the fluid channel receives the fluid sample and an outlet conduit through which at least a portion of the fluid sample is dispensed from the fluid channel.

19. The fluid sampling cartridge of claim 1, further comprising an inlet tube defining a conduit configured to be connected to a peritoneal dialysis (PD) drain bag at a first tube end thereof and the slide body at an opposite second tube end thereof to establish a fluid connection between the PD drain bag and the slide body.

20. The fluid sampling cartridge of claim 1, further comprising an outlet tube defining a conduit configured to be connected to a fluid sampling system outlet at a first tube end thereof and the slide body at an opposite second tube end thereof to establish a fluid connection between the slide body and the fluid sampling system outlet.
